(19) United States
(12) Patent Application Publication
(10) Pub. No.: US 2005/0207630 A1
(43) Pub. Date: Sep. 22, 2005

(54) Lung nodule detection and classification

(75) Inventors: Heang-Ping Chan, Ann Arbor, MI (US); Berkman Sahiner, Ann Arbor, MI (US); Lubomir M Hadjiyski, Ann Harbor, MI (US); Chuan Zhou, Ann Arbor, MI (US); Nicholas Petrick, Silver Spring, MD (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: The Regents of the University of Michigan Technology Management Office, Ann Arbor, MI (US)

(21) Appl. No.: 10/504,197

(22) PCT Filed: Feb. 14, 2003
(86) PCT No.: PCT/US03/04699

§ 371 Date: Mar. 25, 2005

Related U.S. Application Data
(60) Provisional application No. 60/357,518, filed on Feb. 15, 2002.
(60) Provisional application No. 60/418,617, filed on Oct. 15, 2002.

(51) Int. Cl. G06K 9/00

(52) U.S. Cl. 382/131

(57) ABSTRACT

A computer assisted method of detecting and classifying lung nodules within a set of CT images includes performing body contour, airway, lung and esophagus segmentation to identify the regions of the CT images in which to search for potential lung nodules. The lungs are processed to identify the left and right sides of the lungs and each side of the lung is divided into subregions including upper, middle and lower subregions and central, intermediate and peripheral subregions. The computer analyzes each of the lung regions to detect and identify a three-dimensional vessel tree representing the blood vessels at or near the mediastinum. The computer then detects objects that are attached to the lung wall or to the vessel tree to assure that these objects are not eliminated from consideration as potential nodules. Thereafter, the computer performs a pixel similarity analysis on the appropriate regions within the CT images to detect potential nodules and performs one or more expert analysis techniques using the features of the potential nodules to determine whether each of the potential nodules is or is not a lung nodule. Thereafter, the computer uses further features, such as speculation features, growth features, etc. in one or more expert analysis techniques to classify each detected nodule as being either benign or malignant. The computer then displays the detection and classification results to the radiologist to assist the radiologist in interpreting the CT exam for the patient.

### RELATED APPLICATIONS

This claims the benefit under 35 U.S.C. §119(e) of U.S. Provisional Application Ser. No. 60/357,518, entitled “Computer-Aided Diagnosis (CAD) System for Detection of Lung Cancer on Thoracic Computed Tomographic (CT) Images” which was filed Feb. 15, 2002, the disclosure of which, in its entirety, is incorporated herein by reference and claims the benefit under U.S.C. §119(e) of U.S. Provisional Application Ser. No. 60/418,617, entitled “Lung Nodule Detection on Thoracic CT Images: Preliminary Evaluation of a Computer-Aided Diagnosis System” which was filed Oct. 15, 2002, the disclosure of which, in its entirety, is incorporated herein by reference.

### FIELD OF TECHNOLOGY

This relates generally to computed tomography (CT) scan image processing and, more particularly, to a system and method for automatically detecting and classifying lung cancer based on the processing of one or more sets of CT images.

### DESCRIPTION OF THE RELATED ART

Cancer is a serious and pervasive medical condition that has garnered much attention in the past 50 years. As a result there has and continues to be significant effort in the medical and scientific communities to reduce deaths resulting from cancer. While there are many different types of cancer, including for example, breast, lung, colon, prostate, etc. cancer, lung cancer is currently the leading cause of cancer deaths in the United States. The overall five-year survival rate for lung cancer is currently approximately 15.6%. While this survival rate increases to 51.4% if the cancer is localized, the survival rate decreases to 2.2% if the cancer has metastasized. While breast, colon, and prostate cancer have seen improved survival rates within the 1974-1990 time period, there has been no significant improvement in the survival of patients with lung cancer.

One reason for the lack of significant progress in the fight against lung cancer may be due to the lack of a proven screening test. Periodic screening using CT images in prospective cohort studies has been found to improve stage one distribution and resectabilitv of lung cancer. Initial findings from a baseline screening of 1000 patients in the Early Lung Cancer Action Project (ELCAP) indicated that low dose CT can detect four times more malignant lung nodules than computed x-ray (CXR) techniques, and six times more stage one malignant nodules, which are potentially more treatable. Unfortunately, the number of images that needs to be interpreted in CT screening is high, particularly when a multi-detector helical CT detector and thin collimation are used to produce the CT images.

The analysis of CT images to detect lung nodules is a demanding task for radiologists due to the number of different images that need to be analyzed by the radiologist. Thus, although CT scanning has a much higher sensitivity than techniques, missed cancers are not uncommon in CT interpretation. To overcome this problem, certain Japanese CT screening programs have begun to use double reading in an attempt to reduce missed diagnosis. However, this methodology doubles the demand on the radiologists' time.

It has been demonstrated in mammographic screening that computer-aided diagnosis (CAD) can increase the sensitivity of breast cancer detection in a clinical setting making it seem likely that improvement in lung cancer screening may benefit from the use of CAD techniques. In fact, numerous researchers have recently begun to explore the use of CAD methods for lung cancer screening. For example, U.S. Pat. No. 5,881,124 discloses a CAD system that uses multi-level thresholding of the CT sections and that uses complex decision trees (as shown in FIGS. 12 and 18 of that patent) to detect lung cancer nodules. As discussed in Kanazawa et al., “Computer-Aided Diagnosis for Pulmonary Nodules Based on Helical CT Images,” Computerized Medical Imaging and Graphics 157-167 (1998) and Satoh et al, “Computer Aided Diagnosis System for Lung Cancer Based on Retrospective Helical CT image,” SPIE Conference on Image Processing, San Diego, Calif., 3661, 1324-1335, (1999), Japanese researchers have developed a prototype system and reported high detection sensitivity in an initial evaluation. In this study, the researchers used gray-level thresholding to segment the lung region. Next, blood vessels and nodules were segmented using a fuzzy clustering method. The artifacts and small regions were then reduced by thresholding and morphological operations. Several features were extracted to differentiate between blood vessels and potential cancerous nodules and most of the false positive nodule candidates were reduced through rule-based classification.

Similarly, as discussed in Lou et al., “Object-Based Deformation Technique for 3-D CT Lung Nodule Detection,” SPIE Conference on Image Processing, San Diego, Calif., 3661, 1544-1552, (1999), researchers developed an object-based deformation technique for nodule detection in CT images and initial segmentation on 18 cases was reported. Fiebich et al., “Automatic Detection of Pulmonary Nodules in Low-Dose Screening Thoracic CT Examinations,” SPIE Conference on Image Processing, San Diego, Calif., 3661, 1436-1439, (1999) and Arnato et al., “Three-Dimensional Approach to Lung Nodule Detection in Helical CT,” SPIE Conference on Image Processing, San Diego, Calif., 3662, 553-559, (1999) reported the performance of their automated nodule detection schemes in 17 cases. The sensitivity and specificity were 95.7 percent, with 0.3 false positive (FP) per image in the former study, and 72% with 4.6 FPs per image in the latter.

However, a recent evaluation of the CAD system on 26 CT exams as reported in Wormanns et al., “Automatic Detection of Pulmonary Nodules at Spiral CT—First Clinical Experience with a Computer-Aided Diagnosis System,” SPIE Medical Imaging 2000: Image Processing, San Diego, Calif., 3979, 129-135, (2000), resulted in a much lower sensitivity of 30 percent, at 6.3 FPs per CT study. Likewise, Aimato et al., “Computerized Lung Nodule Detection: Comparison of Performance for Low-Dose and Standard-Dose Helical CT Scans,” Proc. SPIE 4322 (2001), recently reported a 70 percent sensitivity with 1.7 FPs per slice in a data set of 43 cases. In this case, they used multi-level gray-level segmentation for the extraction of nodule candidates from CT images. Ko and Betke, “Chest CT: Automated Nodule Detection and Assessment of Change Over Time-Preliminary Experience,” Radiology 2001, 267-273 (2001) discusses a system that semi-automatically identified nodules, quantified their diameter, and assessed change in size at follow-up. This article reports an 86 percent detection rate at 2.3 FPs per image in 16 studies and found that the assessment of nodule size change by the computer was comparable to that by a thoracic radiologist. Also, Hara et al., “Automated Lesion Detection Methods for 2D and 3D Chest X-Ray Images,” International Conference on Image Analysis and Processing, 768-773, (1999) used template matching techniques to detect nodules. The size and the location of the two dimension Gaussian templates were determined by the genetic algorithm. The sensitivity of the system was 77 percent at a 2.6 FP per image. These reports indicate that computerized detection for lung nodules in helical CT images is promising. However, they also demonstrate large variations in performance, indicating that the computer vision techniques in this area have not been fully developed and are not at an acceptable level to use at a clinical setting.

### BRIEF SUMMARY OF DISCLOSURE

A computer assisted method of detecting and classifying lung nodules within a set of CT images for a patient, so as to diagnose lung cancer, includes performing body contour segmentation, airway and lung segmentation and esophagus segmentation to identify the regions of the CT images in which to search for potential lung nodules. The lungs as identified within the CT images are processed to identify the left and right regions of the lungs and each of these regions of the lungs is divided into subregions including, for example, upper, middle and lower subregions and central, intermediate and peripheral subregions. Further processing may be performed differently in which of the subregions to perform better detection and classification of lung nodules.

The computer may also analyze each of the lung regions on the CT images to detect and identify a three-dimensional vessel tree representing the blood vessels at or near the mediastinum. This vessel tree can then be used to prevent the identified vessels from being detected as lung nodules in later processing steps. Likewise, the computer may detect objects that are attached to the lung wall and may detect objects that are attached to and identified as part of the vessel tree to assure that these objects are not eliminated from consideration as potential nodules.

Thereafter, the computer may perform a pixel similarity analysis on the appropriate regions within the CT images to detect potential nodules. Each potential nodule may be tracked or identified in three dimensions using three dimensional image processing techniques. Thereafter, to reduce the false positive detection of nodules, the computer may perform additional processing to identify vascular objects within the potential nodule candidates. The computer may then perform shape improvement on the remaining potential nodules.

Two dimensional and three dimensional object features, such as size, shape, texture, surface and other features are then extracted or determined for each of the potential nodules and one or more expert analysis techniques, such as a neural network engine, a linear discriminant analysis (LDA), a fuzzy logic or a rule-based expert engine, etc. is used to determine whether each of the potential nodules is or is not a lung nodule. Thereafter, further features, such as speculation features, growth features, etc. may be obtained for each of the nodules and used in one or more expert analysis techniques to classify that nodule as either being benign or malignant.

### BRIEF DESCRIPTION OF DRAWINGS

FIG. 1 is a block diagram of a computer aided diagnostic system that can be used to perform lung cancer screening and diagnosis based on a series of CT images using one or more exams from a given patient;

FIG. 2 is a flow chart illustrating a method of processing a set of CT images for one or more patients to screen for lung cancer and to classify any determined cancer as benign or malignant;

FIG. 3A is an original CT scan image from one set of CT scans taken of a patient;

FIG. 3B is an image depicting the lung regions of the CT scan image of FIG. 3A as identified by a pixel similarity analysis algorithm;

FIG. 4A is a contour map of a lung having connecting left and right lung regions, illustrating a Minimum-Cost Region Splitting (MCRS) technique for splitting these two lung regions at the anterior junction;

FIG. 4B is an image of the lung after the left and right lung regions have been split;

FIG. 5A is a vertical depiction or slice of a lung divided into upper, middle and lower subregions;

FIG. 5B is a horizontal depiction or slice of a lung divided into central, intermediate and peripheral subregions;

FIG. 6 is a flow chart illustrating a method of tracking a vascular structure within a lung;

FIG. 7A is a three-dimensional depiction of the detected pulmonary vessels detected by tracking;

FIG. 7B is a projection of a three-dimensional depiction of a detected vascular structure within a lung;

FIG. 8A is a contour depiction of a lung region having a defined lung contour with a juxta-pleura nodule that has been initially segmented as part of the lung wall and a method of detecting the juxta-pleura nodule;

FIG. 8B is a depiction of an original lung image and a detected lung image illustrating the juxta-pleura nodule of FIG. 8A;

FIG. 9 is CT scan image having a nodule and two vascular objects initially identified as nodule candidates therein;

FIG. 10A is a graphical depiction of a method used to detect long, thin structures in an attempt to identify likely vascular objects within a lung;

FIG. 10B is a graphical depiction of another method used to detect Y-shaped or branching structures in an attempt to identify likely vascular objects within a lung; and

FIG. 11 illustrates a contour model of an object identified in three dimensions by connecting points or pixels on adjacent two dimensional CT images.

### DETAILED DESCRIPTION

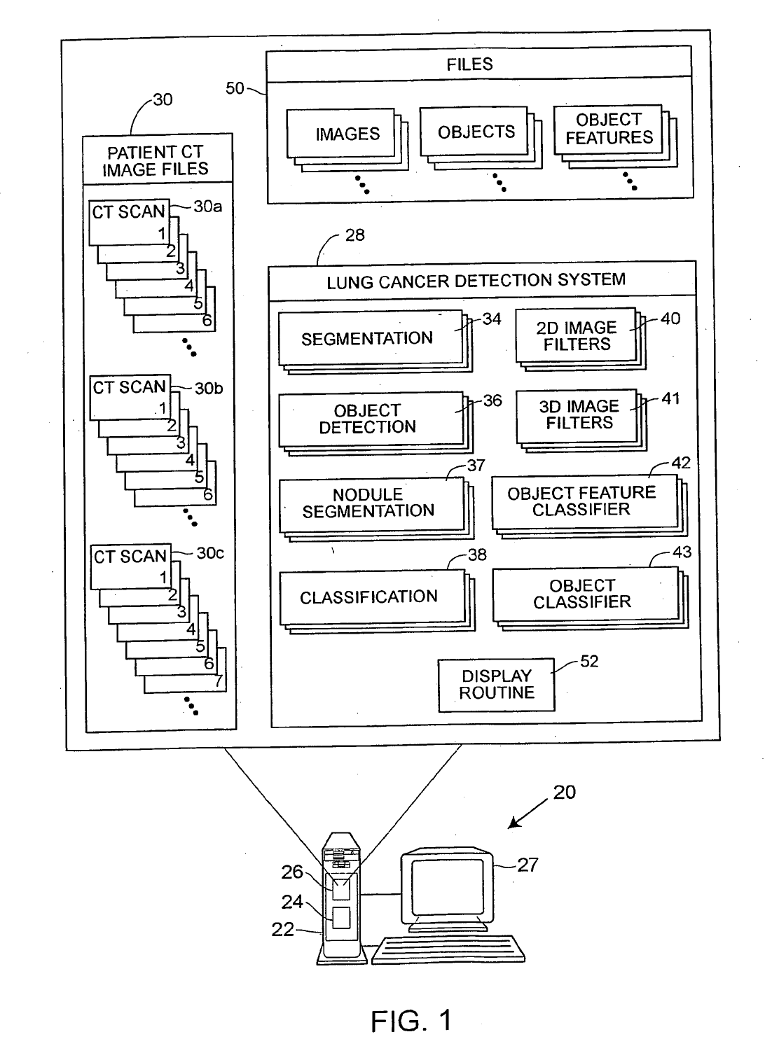

Referring to FIG. 1, a computer aided diagnosis (CAD) system 20 that may be used to detect and diagnose lung cancer or nodules includes a computer 22 having a processor 24 and a memory 26 therein and having a display screen 27 associated therewith, which may be, for example, a Barco MGD52I monitor with a P104 phosphor and 2K by 2.5K pixel resolution. As illustrated in an expanded view of the memory 26, a lung cancer detection and diagnostic system 28 in the form of, for example, a program written in computer implementable instructions or code, is stored in the memory 26 and is adapted to be executed on the processor 24 to perform processing on one or more sets of computed tomography (CT) images 30, which may also stored in the computer memory 26. The CT images 30 may include CT images for any number of patients and may be entered into or delivered to the system 20 using any desired importation technique. Generally speaking, any number of sets of images 30a, 30b, 30c, etc. (called image files) can be stored in the memory 26 wherein each of the image files 30a, 30b, etc. includes numerous CT scan images associated with a particular CT scan of a particular patient. Thus, different ones of the images files 30a, 30b, etc. may be stored for different patients or for the same patient at different times. As noted above, each of the image files 30a, 30b, etc. includes a plurality of images therein corresponding to the different slices of information collected by a CT imaging system during a particular CT scan of a patient. The actual number of stored scan images in any of the image files 30a, 30b, etc. will vary depending on the size of the patient, the scanning image thickness, the type of CT scanner used to produce the scanned images in the image file, etc. While the image files 30 are illustrated as stored in the computer memory 26, they may be stored in any other memory and be accessible to the computer 22 via any desired communication network, such as a dedicated or shared bus, a local area network (LAN), wide area network (WAN), the internet, etc.

As also illustrated in FIG. 1, the lung cancer detection and diagnostic system 28 includes a number of components or routines 32 which may perform different steps or functionality in the process of analyzing one or more of the image files 30 to detect and/or diagnose lung cancer nodules. As will be explained in more detail herein, the lung cancer detection and diagnostic system 28 may include lung segmentation routines 34, object detection routines 36, nodule segmentation routines 37, and nodule classification routines 38. To perform these routines 34-38, the lung cancer detection and diagnostic system 28 may also include one or more two dimensional and three dimension image processing filters 40 and 41, object feature classification routines 42, object classifiers 43, such as neural network analyzers, linear discriminant analyzers which use linear discriminant analysis routines to classify objects, rule based analyzers, including standard or crisp rule based analyzers and fuzzy logic rule based analyzers, etc., all of which may perform classification based on object features provided thereto. Of course other image processing routines and devices may be included within the system 28 as needed.

Still further, the CAD system 20 may include a set of files 50 that store information developed by the different routines 32-38 of the system 28. These files 50 may include temporary image files that are developed from one or more of the CT scan images within an image file 30 and object files that identify or specify objects within the CT scan images, such as the locations of body elements like the lungs, the trachea, the primary bronchi, the vascular network within the lungs, the esophagus, etc. The files 50 may also include one or more object files specifying the location and boundaries of objects that may be considered as lung nodule candidates, and object feature files specifying one or more features of each of these objects as determined by the object feature classifying routines 42. Of course, other types of data may be stored in the different files 50 for use by the system 28 to detect and diagnose lung cancer nodules from the CT scan images of one or more of the image files 30.

Still further, the lung cancer detection and diagnostic system 28 may include a display program or routine 52 that provides one or more displays to a user, such as a radiologist, via, for example, the screen 27. Of course, the display routine 52 could provide a display of any desired information to a user via any other output device, such as a printer, via a personal data assistant (PDA) using wireless technology, etc.

During operation, the lung cancer detection and diagnostic system 28 operates on a specified one or ones of the image files 30a, 30b, etc. to detect and, in some cases, diagnose lung cancer nodules associated with the selected image file. After performing the detection and diagnostic functions, which will be described in more detail below, the system 28 may provide a display to a user, such as a radiologist, via the screen 27 or any other output mechanism, connected to or associated with the computer 22 indicating the results of the lung cancer detection and screening process. Of course, the CAD system 20 may use any desired type of computer hardware and software, using any desired input and output devices to obtain CT images and display information to a user and may take on any desired form other than that specifically illustrated in FIG. 1.

Generally speaking, the lung cancer detection and diagnostic system 28 processes the numerous CT scan images in one (or more) of the image files 30 using one or more two-dimensional (2D) image processing techniques and/or one or more three-dimensional (3D) image processing techniques. The 2D image processing techniques use the data from only one of image scans (which is a 2D image) of a selected image file 30 while 3D image processing techniques use data from multiple image scans of a selected image file 30. Generally speaking, although not always, the 2D techniques are applied separately to each image scan within a particular image file 30.

The different 2D and 3D image processing techniques, and the manners of using these techniques described herein, are generally used to identify nodules located within the lungs which may be true nodules or false positives, and further to determine whether an identified lung nodule is benign or malignant. As an overview, the image processing techniques described herein may be used alone, or in combination with one another, to perform one of a number of different steps useful in identifying potential lung cancer nodules, including identifying the lung regions of the CT images in which to search for potential lung cancer nodules, eliminating other structures, such as vascular tissue, the trachea, bronchi, the esophagus, etc. from consideration as potential lung cancer nodules, screening the lungs for objects that may be lung cancer nodules, identifying the location, size and other features of each of these objects to enable more detailed classification of these objects, using the identified features to detect an identified object as a lung cancer nodule and classifying identified lung cancer nodules as either benign or malignant. While the lung cancer detection and diagnostic system 28 is described herein as performing the 2D and 3D image processing techniques in a particular order, it will be understood that these techniques may be applied in other orders and still operate to detect and diagnose lung cancer nodules. Likewise, it is not necessary in all cases to apply each of the techniques described herein, it being understood the some of these techniques may be skipped or may be substituted with other techniques and still operate to detect lung cancer nodules.

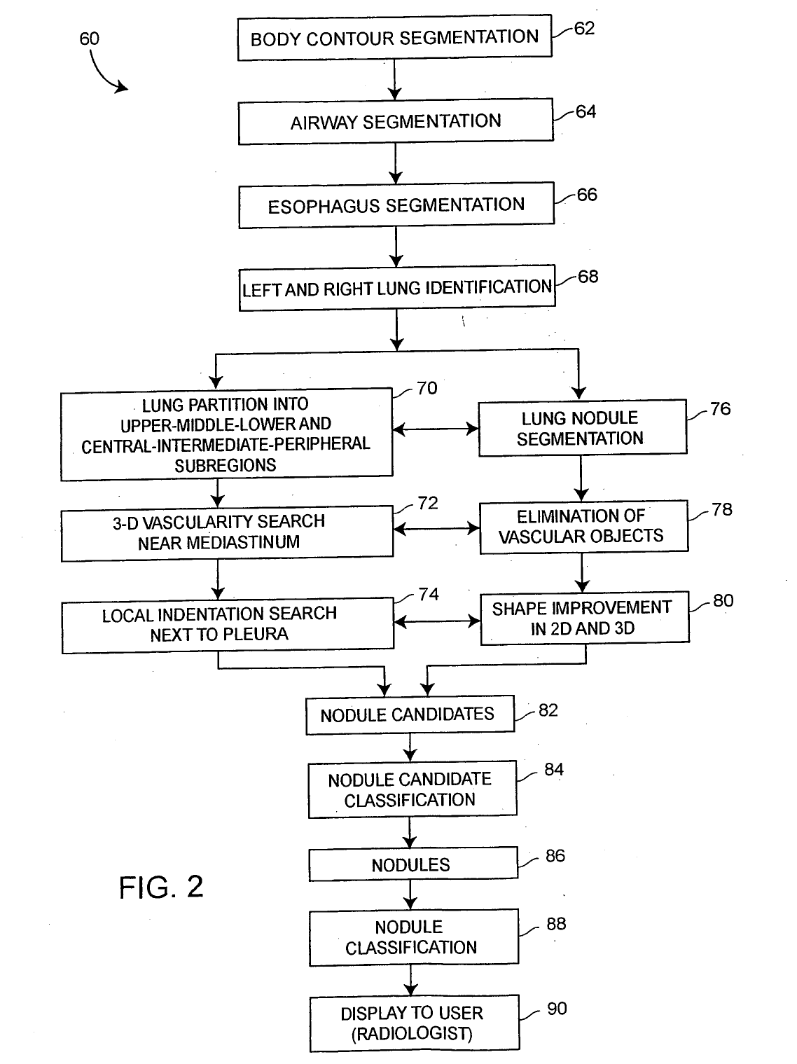

FIG. 2 depicts a flow chart 60 that illustrates a general method of performing lung cancer nodule detection and diagnosis for a patient based on a set of previously obtained CT images for the patient as well as a method of determining whether the detected lung cancer nodules are benign or malignant. The flow chart 60 of FIG. 2 may generally be implemented by software or firmware as the lung cancer detection and diagnostic system 28 of FIG. 1 if so desired. Generally speaking, the method of detecting lung cancer depicted by the flow chart 60 includes a series of steps 62-68 that are performed on each of the two dimensional CT images (2D processing) or on a number of these images together (3D processing) for a particular image file 30 of a patient to identify and classify the areas of interest on the CT images (i.e., the areas of the lungs in which nodules may be detected), a series of steps 70-80 that generally process these areas to determine the existence of potential cancer nodules or nodule candidates 82, a step 84 that classifies the identified nodule candidates 82 as either being actual lung nodules or as not being lung nodules to produce a detected set of nodules 86 and a step 88 that performs nodule classification on each of the nodules 86 to diagnose the nodules 86 as either being benign or malignant. Furthermore, a step 90 provides a display of the detection and classification results to a user, such as radiologist. While, in many cases, these different steps are interrelated in the sense that a particular step may use the results of one or more of the previous steps, which results may be stored in one of the files 50 of FIG. 1, it will be understood that the data, such as the raw CT image data, images processed or created from these images, and data stored as related to or obtained from processing these images is made available as needed to each of the steps of FIG. 2.

1. Body Contour Segmentation

Referring now to the step 62 of FIG. 2, the lung cancer detection and diagnostic system 28 and, in particular, one of the segmentation routines 34, processes each of the CT images of a selected image file 30 to perform body contour segmentation with the goal of separating the body of the patient from the air surrounding the patient. This step is desirable because only image data associated with the body and, in particular, the lungs, will be processed in later steps to detect and identify potential lung cancer nodules. If desired, the system 28 may segment the body portion within each CT scan from the surrounding air using a simple constant gray level thresholding technique in which the outer contour of the body may be determined as the transition between a higher gray level and a lower gray level of some preset threshold value. If desired, a particular low gray level may be chosen as being an air pixel and eliminated, or a difference between two neighboring pixels may be used to define the transition between the body and the air. This simple thresholding technique may be used because the CT values of the mediastinum and lung walls are much higher than that of the air surrounding the patient and, as a result, an approximate threshold can successfully separate the surrounding air region and the thorax for most or all cases. If desired, a low threshold value, e.g., −800 Hounsfield units (HU), may be used to exclude the image region external to the thorax. However, other threshold values may be used as well. Once thresholding is performed, the pixels above the threshold are grouped into objects using 26-connectivity (described below in step 64). The largest of these defined objects is determined as the patient body. The body object is filled using a known flood-fill algorithm, i.e., one that assigns pixels contained within a closed boundary of the body object pixels to the body.

Alternatively, the step 62 may use an adaptive technique to determine appropriate grey level thresholds to use to identify this transition, which threshold may vary somewhat based on the fact that the CT image density (and therefore gray value of image pixels) tends to vary according to the x-ray beam quality, scatter, beam hardening, and calibration used by the CT scanner. According to this adaptive techniques the step 62 may separate the air or body region from the thorax region using a bimodal histogram in which the external/internal transition threshold is chosen based on the gray level histogram of each of the CT scan images.

Of course, once determined, the thorax region or body region, such as the body contour of each CT scan image will be stored in the memory in, for example, one of the files 50 of FIG. 1. Furthermore, these images or data may be retrieved during other processing steps to reduce the amount of processing that needs to be performed on any given CT scan image.

2. Airway and Lung Segmentation

Once the thorax region is identified, the step 64 defines or segments the lungs and the airway passages, generally including the trachea and the bronchi, etc., in each CT scan image from the rest of the body structure (the thorax identified in the step 62), generally including the esophagus, the spine, the heart, and other internal organs.

The lung regions and the airways are segmented (step 64) using a pixel similarity analysis designed for this purpose. The pixel similarity analysis can be applied to the individual CT slice (2D segmentation) or to the entire set of CT images covering the thorax (3D segmentation). Further processing after the pixel similarity analysis such as the identification and splitting of the left and right lungs can be performed slice by slice. For the pixel similarity analysis, the properties of a given pixel in the lung regions and in the surrounding tissue are described by a feature vector that may include, but is not limited to, its pixel value and the filtered pixel value that incorporates the neighborhood information (such as median filter, gradient filter, or others). The pixel similarity analysis assigns the membership of a given pixel into one of two class prototypes: the lung tissue and the surrounding structures as follows.

The centroid of the object class prototype (i.e., the lung and airway regions) or the centroid of the background class prototype (i.e., the surrounding structures) are defined as the centroid of the feature vectors of the current members in the respective class prototype. The similarity between a feature vector and the centroid of a class prototype can be measured by the Euclidean distance or a generalized distance measure, such as the squared distance, with shorter distance indicating greater similarity. The membership of a given pixel (or its feature vector) is determined iteratively by the class similarity ratio between the two classes. The pixel is assigned to the class prototype at the denominator if the class similarity ratio exceeds a threshold. The threshold is obtained from training with a large data set of CT cases. The centroid of a class prototype is updated (recomputed) after each iteration when all pixels in the region of interest have been assigned a membership. The process of membership assignment will then be repeated using the updated centroids. The iteration is terminated when the changes in the class centroids fall below a predetermined threshold. At this point, the member pixels of the two class prototypes are finalized and the lung regions and the airways are separated from the surrounding structures.

In a further step the lung regions are separated from the trachea and the primary bronchi by K-means clustering, such as or similar to the one discussed in Hara et al., “Applications of Neural Networks to Radar Image Classification,” IEEE Transactions on Geoscience and Remote Sensing 32, 100-109 (1994), in combination with 3D region growing. In a 3D thoracic CT image, since the trachea is the only major airspace in the upper few slices, it can be easily identified after clustering and used as the seed region. 3D region growing is then employed to track the airspace within the trachea starting from the seed region in the upper slices of the 3D volume. The trachea is tracked in three dimensions through the successive slices (i.e., CT scan image slices) until it splits into the two primary bronchi. The criteria for growing include spatial connectivity, and gray-level continuity as well as the curvature and the diameter of the detected object during growing.

In particular, connectivity of points (i.e., pixels in the trachea and bronchi) may be defined using 26 point connectivity in which the successive images from different but adjacent CT scans are used to define a three dimensional space. In this space, each point or pixel can be defined as a center point surrounded by 26 adjacent points defining a surface of a cube. There will be nine points or pixels taken from each of three successive CT image scans with the point of interest being the point in the middle of the middle or second CT scan image slice. According to this connectivity, the center point is “connected” to each of the 26 points on the surface of the cube and this connectivity can be used to define what points may be connected to other points in successive CT image scans when defining or growing the airspace within the trachea and bronchi.

Additionally, gray-level continuity may be used to define or grow the trachea and bronchi by not allowing the region being defined or grown to change in gray level or gray value over a certain amount during any growing step. In a similar manner, the curvature and diameter of the object being grown may be determined and used to help grow the object. For example, the cross section of the trachea and bronchi in each CT scan image will be generally circular and, therefore, will not be allowed to be grown or defined outside of a certain predetermined circularity measure. Similarly, these structures are expected to generally decrease in diameter as the CT scans are processed from the top to the bottom and, thus, the growing technique may not allow a general increase in diameter of these structures over a set of successive scans. Additionally, because these structures are not expected to experience rapid curvature as they proceed down through the CT scans, the growing technique may select the walls of the structure being grown based on pre-selected curvature measures. These curvature and diameter measures are useful in preventing the trachea from being grown into the lung regions on slices where the two organs are in close proximity.

The primary bronchi can be tracked in a similar manner, starting from the end of the trachea. However, the bronchi extend into the lung region which makes this identification more complex. To reduce the probability of merging the bronchi with actual lung tissue during the growing technique, conservative growing criteria is applied and an additional gradient measure is used to guide the region growing. In particular, the gradient measure is defined as a change in the gray level value from one pixel (or the average gray level value from one small local region) to the next, such as from one CT scan image to another. This gradient measure is tracked as the bronchi are being grown so that the bronchi walls are not allowed to grow through gradient changes over a threshold that is determined adaptively to the local region as the tracking proceeds.

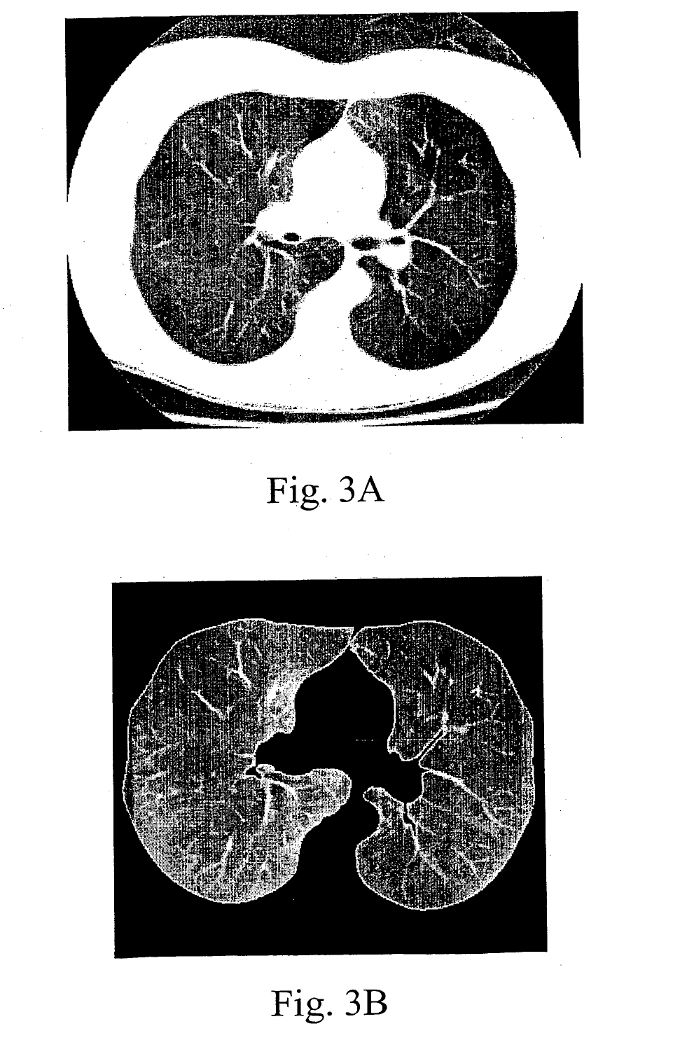

FIG. 3A illustrates an original CT scan image slice and FIG. 3B illustrates a contour segmentation plot that identifies or differentiates the airways, in this case the lungs, from the rest of the body structure based on this pixel similarity analysis technique. It will, of course, be understood that such a technique is or can be applied to each of the CT scan images within any image file 30 and the results stored in one of the files 50 of FIG. 1.

3. Esophagus Segmentation

In the esophagus segmentation process, the step 66 of FIG. 2 will identify the esophagus in each CT scan image so as to eliminate this structure from consideration for lung nodule detection in subsequent steps. Generally, the esophagus and trachea may be identified in similar manners as they are very similar structures.

Therefore, the esophagus may be segmented by growing this structure through the different CT scan images for an image file in the same manner as the trachea, described above in step 64. However, generally speaking, different threshold gray levels, curvatures, diameters and gradient values will be used to detect or define the esophagus using this growing technique as compared to the trachea and bronchi. The general expected shape and location of the anatomical structures in the mediastinal region of the thorax are used to identify the seed region belonging to the esophagus.

In any event, after the esophagus, trachea and bronchi are detected, definitions of these areas or volumes are stored in one of the files 50 of FIG. 1 and this data will be used to exclude these areas or volumes from processing in the subsequent steps segmentation and detection steps. Of course, if desired, the pixels or pixel locations from each scan defined as being within the trachea, bronchi and esophagus may be stored in a file 50 of FIG. 1, a file defining the boundaries of the lung in each CT scan image may be created and stored in the memory 26 and the pixels defining the esophagus, trachea and bronchi may be removed from these files or any other manner of storing data pertaining to or defining the location of the lungs, trachea, esophagus and bronchi may be used as well.

4. Left and Right Lung Identification

At a step 68 of FIG. 2, the system 28 defines or identifies the walls of the lungs and partitions the lung into regions associated with the left and right sides of the lungs. The lung regions are segmented with the pixel similarity analysis described in step 64 airway segmentation. In some cases, the inner boundary of the lung regions will be refined by using the information of the segmented structures in the mediastinal region including the esophagus, trachea and bronchi structures defined in the segmentation steps 62-66.

The left and right sides of the lung may be identified using an anterior junction line identification technique. The purpose of this step is to identify the left and right lungs in the detected airspace by identifying the anterior junction line of each of the two sides of the lungs. In one case, to define the anterior junction, the step 68 may define the two largest but separate airspace objects on each CT scan image as candidates for the right and left lungs. Although the two largest objects usually correspond to the right and left lungs, there are a number of exceptions, such as (1) in the upper region of the thorax where the airspace may consist of only the trachea; (2) in the middle region in which case the right and left lungs may merge to appear as a single object connected together at the anterior junction line; and (3) in the lower region, wherein the air inside the bowels can be detected as airspace by the pixel similarity analysis algorithm performed by the step 64.

If desired, a lower bound or threshold of detected airspace area in each CT scan image can be used to solve the problems of cases (1) and (3) discussed above. In particular, by ignoring CT scan images that do not have an air space area above the selected threshold value, the CT scan images having only the trachea and bowels therein can be ignored. Also, if the trachea has been identified previously, such as by the step 66, the lung identification technique can ignore these portions of the CT scans when identifying the lungs.

As noted above however, it is often the case that the left and right sides of the lungs appear to be merged together, such as at the top of the lungs, in some of the CT scan image slices. A separate algorithm may be used to detect this condition and to split the lungs in each of the 2D CT scans where the lungs are merged. In particular, a detection algorithm for detecting the presence of merged lungs may start at the top of the set of CT scan images and look for the beginning or very top of the lung structure.

To detect the top of the lung structure, an algorithm, such as one of the segmentation routines 34 of FIG. 1, may threshold each CT scan image on the amount of airspace (or lung space) in the CT scan image and identify the top of the lung structure when a predetermined threshold of air space exists in the CT scan image. This thresholding prevents detection of the top of the lung based on noise, minor anomalies within the CT scan image or on airways that are not part of the lung, such as the trachea, esophagus, etc.

Once the first or topmost CT scan image with a predetermined amount of airspace is located, the algorithm at the step 68 determines whether that CT scan image includes both the left and right sides of the lungs (i.e., the topmost parts of these sides of the lungs) or only the left or the right side of the lung (which may occur when the top of one side of the lung is disposed above or higher in the body than the top of the other side of the lung). To determine if both or only a single side of the lung structure is present in the CT scan image, the step 68 may determine or calculate the centroid of the lung region within the CT image scan. If the centroid is clearly on the left or right side of the lung cavity, e.g., a predetermined number of pixels away from the center of the CT image scan, then only the left or right side of the lung is present. If the centroid is in the middle of the CT image scan, then both sides of the lungs are present. However, if both sides of the lung are present, the left and right sides of the lungs may be either separated or merged.

Alternatively or in addition, the algorithm at the step 68 may select the two largest but separate lung objects in the CT scan image (that is, the two largest airway objects defined as being within the airways but not part of the trachea, or bronchi) and determine the ratio between the sizes (number of pixels) of these two objects. If this ratio is less than a predetermined ratio, such as ten-to-one (10/1), than both sides of the lung are present in the CT scan image. If the ratio is greater than the predetermined threshold, such as 10/1, then only one side of the lung is present or both sides of the lungs are present but are merged.

If the step 68 determines that the two sides of the lungs are merged because, for example, the centroid of the airspace is in the middle of the lung cavity but the ratio of the two largest objects is greater than the predetermined ratio then the algorithm of the step 68 may look for a bridge between the two sides of the lung by, for example, determining if there the lung structure has two wider portions with a narrower portion therebetween. If such a bridge exists, the left and right sides of the lungs may be split through this bridge using, for example, the minimum cost region splitting (MCRS) algorithm.

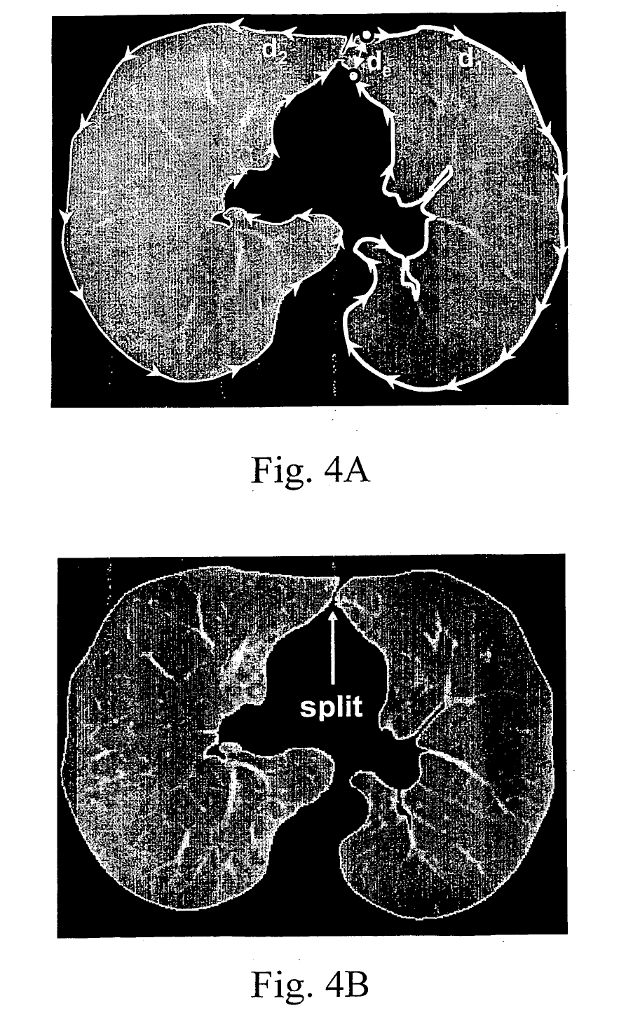

The minimum cost region splitting algorithm, which is applied individually on each different CT scan image slice in which the lungs are connected, is a rule-based technique that separates the two lung regions if they are found to be merged. According to this technique, a closed contour along the boundary of the detected lung region is constructed using a boundary tracking algorithm. Such a boundary is illustrated in the contour diagram of FIG. 4A. For every pair of points in the anterior junction region along this contour, three distances are calculated as shown in FIG. 4A. The first two distances (d1 and d2) are the distances between these two points measured by traveling along the contour in the counter-clockwise and the clockwise directions, respectively. The third distance, de, is the Euclidean distance, which is the length of the line connecting these two points. Next, the ratio of the minimum of the first two distances to the Euclidean distance is calculated. If this ratio, R, is greater than a pre-selected threshold, the line connecting these two points is stored as a splitting candidate. This process is repeated until all of the possible splitting candidates have been determined. Thereafter, the splitting candidate with the highest ratio is chosen as the location of lung separation and the two sides of the lungs are separated along this line. Such a split is illustrated in FIG. 4B.

While this process is successful in the separation of joined left and right lungs regions, it may detect a line of separation that is slightly different than the actual junction line. However, this difference is not critical to subsequent lung cancer nodule detection process as this separated lung information is mainly used in two places, namely, while recovering lung wall nodules, and while dividing each lung region into central, intermediate and peripheral sub-regions. Neither of these processes required a very accurate separation of left and right lung regions. Therefore, this method provides an efficient manner of separating the left and right lung regions rather than a more computationally expensive operation.

Although this technique, which is applied in 2D on each CT scan image slice in which the right and left lungs appear to be merged, is generally adequate, the step 68 may implement a more generalizable method to identify the left and right sides of the lungs. Such a generalized method may include 3D rules as well as or instead of 2D rules. For example, the bowel region is not connected to the lungs in 3D. As a result, the airspace of the bowels can be eliminated using 3D connectivity rules as described earlier. The trachea can also be tracked in 3D as described above, and can be excluded from further processing. After the trachea is eliminated, the areas and centroids of the two largest objects on each slice can be followed, starting from the upper slices of the thorax and moving down slice by slice. If the lung regions merge as the images move towards the middle of the thorax, there will be a large discontinuity in both the areas and the centroid locations. This discontinuity can be used along with the 2D criterion to decide whether the lungs have merged.

In this case, to separate the lungs, the sternum can first be identified using its anatomical location and gray scale thresholding. For example, in a 4 cm by 4 cm region adjacent to the sternum, the step 68 may search for the anterior junction line between the right and left lungs by using the minimum cost region splitting algorithm described above. Of course, other manners of separating the two sides of the lungs can be used as well.

In any event, once separated, the lungs, the counters of the lungs or other data defining the lungs can be stored in one or more of the files 50 of FIG. 1 and can be used in later steps to process the lungs separately for the detection of lung cancer nodules.

5. Lung Partitioning into Upper, Middle and Lower and Central, Intermediate and Peripheral Subregions

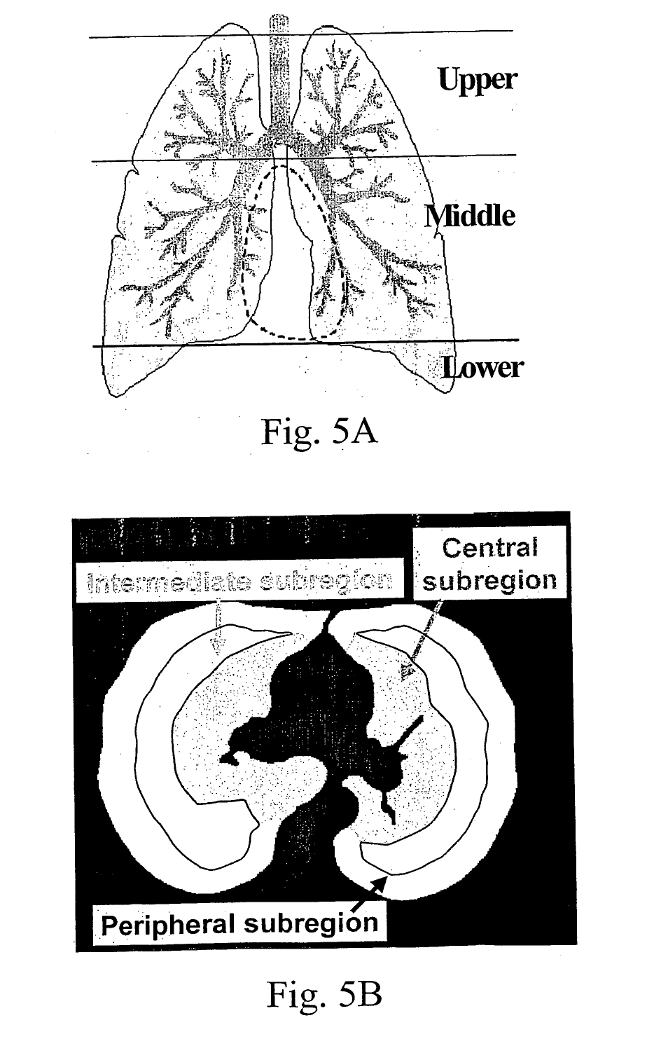

The step 70 of FIG. 2 next partitions the lungs into a number of different 2D and 3D subregions. The purpose of this step is to later enable enhanced processing on nodule candidates or nodules based on the subregion of the lung in which the nodule candidate or the nodule is located as nodules and nodule candidates may have slightly different properties depending on the subregion of the lung in which they are located. While any desired number of lung partitions can be used, in one case, the step 70 partitions each of the lung regions (i.e., the left and right sides of the lungs) into upper, middle and lower subregions of the lung as illustrated in FIG. 5A and partitions each of the left and right lung regions on each CT scan image slice into central, intermediate and peripheral subregions, as shown in FIG. 5B.

The step 70 may identify the upper, middle, and lower regions of the thorax or lungs based on the vasculature structure and border smoothness associated with different parts of the lung, as these features of the lung structure have different characteristics in each of these regions. For example, in the CT scan image slices near the apices of the lung, the blood vessels are small and tend to intersect the slice perpendicularly. In the middle region, the blood vessels are larger and tend to intersect the slice at a more oblique angle. Furthermore, the complexity of the mediastinum varies as the CT scan image slices move from the upper to the lower parts of the thorax. The step 70 may use classifying techniques (as described in more detail herein) to identify and use these features of the vascular structure to categorize the upper, middle and lower portions of the lung field.

Alternatively, if desired, a method similar to the that suggested by Kanazawa et al., “Computer-Aided Diagnosis for Pulmonary Nodules Based on Helical CT images,” Computerized Medical Imaging and Graphics 157-167 (1998), may use the location of the leftmost point in the anterior section of the right lung to identify the transition from the top to the middle portion of the lung. The transition between the middle and lower parts of the lung may be identified as the CT scan image slice where the lung area falls below a predetermined threshold, such as 75 percent, of the maximum lung area. Of course, other methods of portioning the lung in the vertical direction may be used as well or instead of those described herein.

To perform the partitioning into the central, intermediate and peripheral subregions, the pixels associated with the inner and outer walls of each side of the lung may be identified or marked, as illustrated in FIG. 5B by dark lines. Then, for every other pixel in the lungs (with this procedure being performed separately for each of the left and right sides of the lung), the distances between this pixel and the closest pixel on the inner and outer edges of the lung are determined. The ratio of these distances is then determined and the pixel can be categorized as falling into the one of the central, intermediate and peripheral subregions based on the value of this ratio. In this manner, the widths of the central, intermediate and peripheral subregions of each of the left and right sides of the lung are defined in accordance with the width of that side of lung at that point.

In another technique that may be used, the cross section of the lung region may be divided into the central, intermediate and peripheral subregions using two curves, one at ⅓ and the other at ⅔ between the medial and the peripheral boundaries of the lung region, with these curves being developed from and based on the 3D image of the lung (i.e., using multiple ones of the CT scan image slices). In 3D, the lung contours from consecutive CT scan image slices will basically form a curved surface which can be used to partition the lungs into the different central, intermediate and peripheral regions. The proper location of the partitioning curves may be determined experimentally during training on a training set of image files using image classifiers of the type discussed in more detail herein for classifying nodules and nodule candidates.

In a preliminary study with a small data set, the partitioning of the lungs as described above was found to reduce the false positive detection of nodules by 20 percent after the prescreening step by using different rule-based classification in the different lung regions. Furthermore, different feature extraction methods were used to optimize the feature classifiers (described below) in the central, intermediate and peripheral lung regions based on the characteristics of these regions.

Of course, if desired, an operator, such as a radiologist, may manually identify the different subregions of the lungs by specifying on each CT scan image slice the central, intermediate and peripheral subregions and by specifying a dividing line or groups of CT scan image slices that define the upper, middle and lower subregions of each side of the lung.

6. 3D Vascularity Search at Mediastinum

The step 72 of FIG. 2 may perform a 3D vascularity search beginning at, for example, the mediastinum, to identify and track the major blood vessels near the mediastinum. This process is beneficial because the CT scan images will contain very complex structures including blood vessels and airways near the mediastinum. While many of these structures are segmented in the prescreening steps, these structures can still lead to the detection of false positive nodules because the cross sections of the vascular structures mimic nodules, making it difficult to eliminate the false positive detections of nodules in these regions.

To identify the vascular structure near or at the mediastinum, a 3D rolling balloon tracking method in combination with expectation-maximization (EM) algorithm is used to track the major vessels and to exclude these vessels from the image area before nodule detection. The indentations in the mediastinal border of the left and right lung regions can be used as the starting points for growing the vascular structures because these indentations generally correspond to vessels entering and exiting the lung. The vessel is being tracked along its centerline. At each starting point, an initial cube centered at the starting point and having a side length larger than the biggest pulmonary vessel as estimated by anatomy information is used to identify a search volume. An EM algorithm is applied to segment vessel from its background within this volume. A starting sphere is then found which is the minimum sphere enclosing the segmented vessel volume. The center of the sphere is recorded as the first tracked point. At each tracked point, a sphere, the diameter of which is determined to be about 1.5 times to 2 times of the diameter of the vessel at the previously tracked point along the vessel, is centered at the current tracked point.

An EM algorithm is applied to the gray level histogram of the local region enclosed by the sphere to segment the vessel from the surrounding background. The surface of the sphere is then searched for possible intersection with branching vessels as well as the continuation of the current vessel using gray level, size, and shape criteria. All the possible branches are labeled and stored. The center of a vessel is determined as the centroid of the intersecting region between the vessel and the surface of the sphere. The continuation of the current vessel is determined as the branch that has the closest diameter, gray level, and direction as the current vessel, and the next tracked point is the centroid of this branch. The tracking direction is then estimated as a vector pointing from two to three previously tracked points to the current tracked point. The centerline of the vessel is formed by connecting the tracked points along the vessel. As the tracking proceeds, the sphere moves along the tracked vessel and its diameter changes with the diameter of the vessel segment being tracked. This tracking method is therefore referred to as the rolling balloon tracking technique. Furthermore, at each tracked point, gray level similarity and connectivity, as discussed above with respect to the trachea and bronchi tracking may be used to ensure the continuity of the tracked vessel. A vessel is tracked until its diameter and contrast fall below predetermined thresholds or tracked beyond the predetermined region, such as the central or intermediate region of the lungs. Then each of its branches labeled and stored, as described above, will be tracked. The branches of each branch will also be labeled and stored and tracked. The process continues until all possible branches of the vascular tree are tracked. This tracking is preferably performed out to the individual branches terminating in medium to small sized vessels.

Alternatively, if desired, the rolling balloon may be replaced by a cylinder with its axis centered and parallel to the centerline of the vessel being tracked. The diameter of the cylinder at a given tracked point is determined to be about 1.5 to 2 times of the vessel diameter at the previous tracked point. All other steps described for the rolling balloon technique are applicable to this approach.

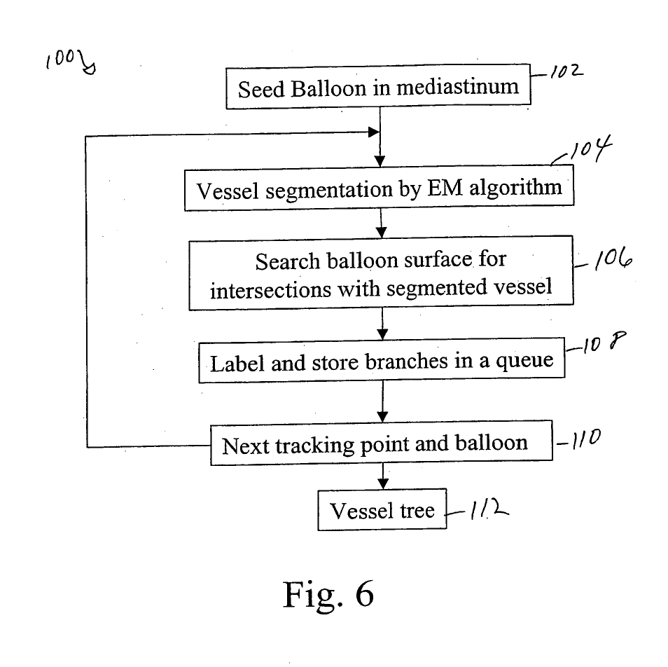

FIG. 6 illustrates a flow chart 100 of a technique that may be used to develop a 3D vascular map in a lung region using this technique. The lung region of interest is identified and the image for this region is obtained from, for example, one of the files 50 of FIG. 1. A block 102 then locates one or more seed balloons in the mediastinum, i.e., at the inner wall of the lung (as previously identified). A block 104 then performs vessel segmentation using an EM algorithm as discussed above. A block 106 searches the balloon surface for intersections with the segmented vessel and a block 108 labels and stores the branches in a stack or queue for retrieval later. A block 110 then finds the next tracking point in the vessel being tracked and the steps 104 to 110 are repeated for each vessel until the end of the vessel is reached. At this point, a new vessel in the form of a previously stored branch is loaded and is tracked by repeating the steps 104 to 110. This process is completed until all of the identified vessels have been tracked to form the vessel tree 112.

This process is performed on each of the vessels grown from the seed vessels, with the branches in the vessels being tracked out to some diameter. In the simplest case, a single set of vessel tracking parameters may be automatically adapted to each seed structure in the mediastinum and may be used to identify a reasonably large portion of the vascular tree. However, some vessels are only tracked as long segments instead of connected branches. This factor can be improved upon by starting with a more restrictive set of vessel tracking parameters but allowing these parameters to adapt to the local vessel properties as the tracking proceeds to the branches. Local control may provide better connectivity than the initial approach. Also, because the small vessels in the lung periphery are difficult to track and some may be connected to lung nodules, the tracking technique is limited to only connected structures within the central vascular region. The central lung region as identified in the lung partitioning method described above for step 70 of FIG. 2 may be used as the vascular segmentation region, i.e., the region in which this 3D vessel tracking procedure is performed.

However, if a lung nodule in the central region of the lung is near a vessel, the vascular tracking technique may initially include the nodule as part of the vascular tree. The nodule needs to be separated from the tree and returned to the nodule candidate pool to prevent missed detection. This step may be performed by separating relatively large nodule-like structures from connecting vessels using 2D or 3D morphological erosion and dilation as discussed in Serra J., Image Analysis and Mathematical Morphology, New York, Academic Press, 1982. In the erosion step, the 2-D images are eroded using a circular erosion element of size 2.5 mm by 2.5 mm, which separates the small objects attached to the vessels from the vessel tree. After erosion, 3-D objects are defined using 26-connectivity. The larger vessels at this stage form another vessel tree, and very small vessels will have been removed. The potential nodules are identified at this stage by checking the diameter of the minimum-sized sphere that encloses each object and the compactness ratio (defined and discussed in detail in step 78 of FIG. 2). If the object is part of the vessel tree, then the diameter of the minimum-sized sphere that encloses the object will be large and the compactness ratio small, whereas if the object is a nodule that has now been isolated from the vessels, the diameter will be small and compactness ratio large. By setting a threshold on the diameter and compactness, potential nodules are identified. A dilation operation using an element size of 2.5 mm by 2.5 mm is then applied to these objects. After dilation, these objects are subtracted from the original vessel tree and sent to the potential nodule pool for further processing.

Of course, the goal of the selection and use of morphological structuring elements is to isolate most nodules from the connecting vessels while minimizing the removal of true vessel branches from the tree. For smaller nodules connected to the vascular tree, morphological erosion will not be as effective because it will not only isolate nodules but will isolate many blood vessels as well. To overcome this problem, feature identification may be preformed in which the diameter, the shape, and the length of each terminal branch is used to estimate the likelihood that the branch is a vessel or, instead, a nodule.

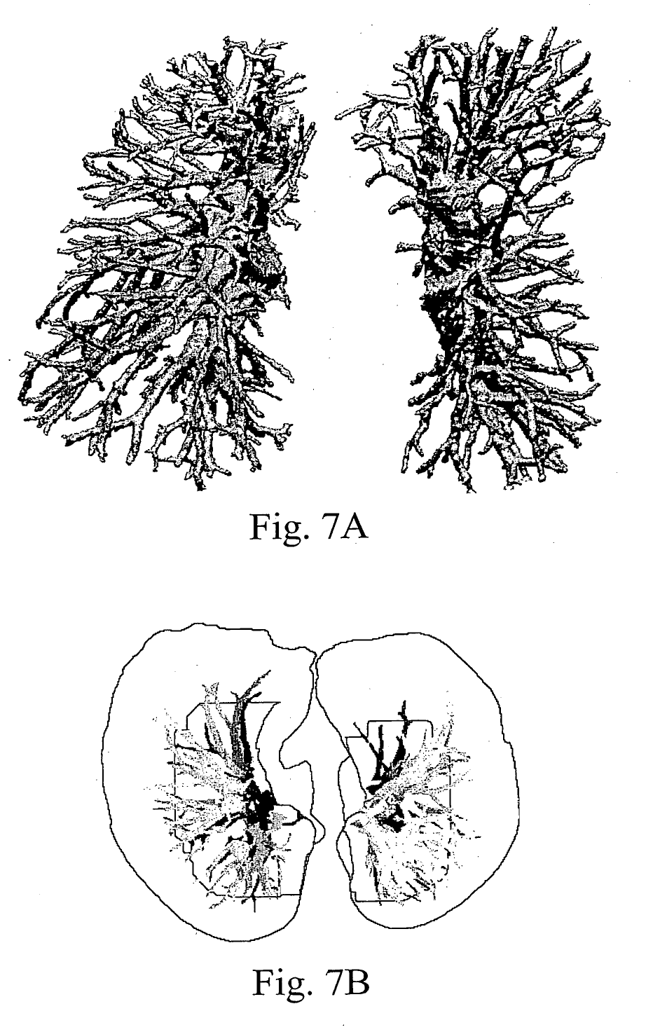

Of course all isolated potential nodules detected using these methods will be returned to the nodule candidate pool (and may be stored in an object or in a nodule candidate file) for further feature identification while the identified vascular regions will be excluded from further nodule searching. FIG. 7A illustrates a three-dimensional view of a vessel tree that may be produced by the technique described herein while FIG. 7B illustrates a projection of such a three-dimensional vascular tree onto a single plane. It will be understood that the vessel tree 112 of FIG. 6, or some identification of it can be stored in one of the files 50 of FIG. 1.

7. Local Indentation Search Next to Pleura

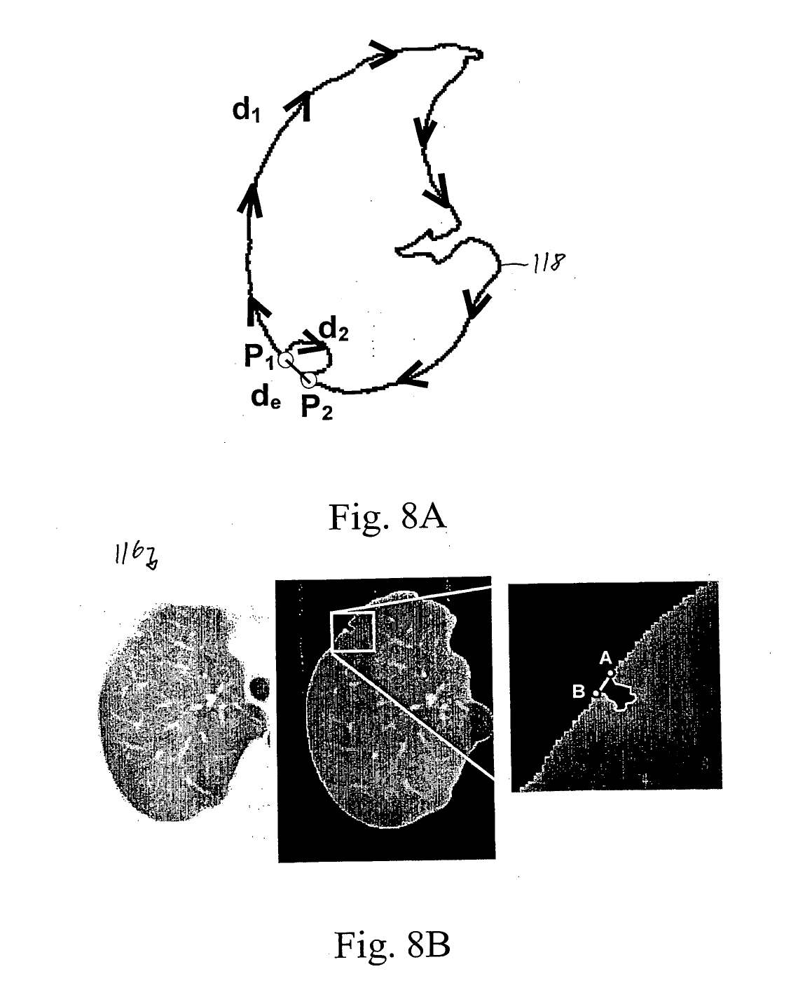

The step 74 of FIG. 2 implements a local indentation search next to the lung pleura of the identified lung stricture in an attempt to recover or detect potential lung cancer nodules that may have been identified as part of the lung wall and, therefore, not within the lung. In particular, there are times when some lung cancer nodules will be located at or adjacent to the wall of the lung and, based on the pixel similarity analysis technique described above in step 64, may be classified as part of the lung wall which, in turn, would eliminate them from consideration as a potential cancer site. FIGS. 8A and 8B illustrate this searching technique in more detail. In particular, FIG. 8B illustrates a CT scan image slice 116 and two successively expanded versions of the lung in which a nodule is attached to the outer lung wall, wherein the nodule has been initially classified as part of the lung wall and, therefore, not within the lung. To reduce or overcome this problem, the step 74 may implement a processing technique to specifically detect the presence of nodule candidates adjacent to or attached to the pleura of the lung.

In one case, a two dimensional circle (rolling ball) can be moved around the identified lung contour. When the circle touches the lung contour or wall at more than one point, these points are connected by a line. In past studies, the curvatures of the lung border were calculated and the border was corrected at locations of rapid curvature by straight lines.

However, a second method that may be used at the step 74 to detect and recover juxta-pleural nodules can be used instead, or in addition to the rolling ball method. According to the second method, as illustrated in the contour image of FIG. 8A, referred to as an indentation extraction method, a closed contour is first determined along the boundary of the lung using a boundary tracking algorithm. Such a closed contour is illustrated by the line 118 in FIG. 8A. For every pair of points P₁ and P₂ along this contour, three distances are calculated. The first two distances, d₁ and d₂, are the distances between P₁ and P₂ measured by traveling along the contour in the counter-clockwise and clockwise directions, respectively. The third distance, dₑ, is the Euclidean distance, which is the length of a straight line connecting P₁ and P₂. In the blown-up section of FIG. 8B two such points are labeled A and B.

Next, the ratio Rₑ of the minimum of the first two distances to the Euclidean distance dₑ is calculated as:

$${R}_{e} = \frac{min ( {ⅆ}_{1} , {ⅆ}_{2} )}{{ⅆ}_{e}}$$

If the ratio, Rₑ is greater than a pre-selected threshold, the lung contour (boundary) between P₁ and P₂ is corrected using a straight line from P₁ to P₂. The value for this threshold may be approximately 1.5, although other values may be used as well. Of course, the equation for Rₑ above could be inverted and, if lower than a predetermined threshold, could cause the use of the straight line between the two points. Likewise, any combination of the distances d₁ and d₂ (such as an average, etc.) could be used in the ratio above instead of the minimum of those distances. When the straight line, such as the line 120 of FIG. 8, is used for the lung wall, the structure defined by the old lung wall, which will fall within the lung, can now be detected as a potential lung cancer nodule. Of course, it will be understood that this produce can be performed on each CT scan image slice to return the 3D nodule (which will generally be disposed on more than one CT scan image slice) to the potential nodule candidate pool.

8. Segmentation of Lung Nodule Candidate Within Lung Regions

Once the lung contours are determined using one or a combination of the processing steps defined above, the step 76 of FIG. 2 may identify and segment potential nodule candidates within the lung regions. The step 76 essentially performs a prescreening step that attempts to identify every potential lung nodule candidate to be later considered when determining actual lung cancer nodules.

To perform this prescreening step, the step 76 may perform a 3D adaptive pixel similarity analysis technique with two output classes. The first output class includes the lung nodule candidates and the second class is the background within the lung region. The pixel similarity analysis algorithm may be similar to that used to segment the lung regions from the surrounding tissue as described in step 64. Briefly, according to this technique, one or more image filters may be applied to the image of the lung region of interest to produce a set of filtered images. These image filters may include, for example, a median filter (use as one using, for example, a 5×5 kernel), a gradient filter, a maximum intensity projection filter centered around the pixel of interest (which filters a pixel as the maximum intensity projection of the pixels in a small cube or area around the pixel), or other desired filters.

Next, a feature vector (in the simplest case a gray level value, or generally, the original image gray level value and the filtered image values as the feature components) may be formulated to define each of the pixels. The centroid of the object class prototype (i.e., the potential nodules) or the centroid of the background class prototype (i.e., the normal lung tissue) are defined as the centroid of the feature vectors of the current members in the respective class prototype. The similarity between a feature vector and the centroid of a class prototype can be measured by the Euclidean distance or a generalized distance measure, such as the squared distance, with shorter distance indicating greater similarity. The membership of a given pixel (or its feature vector) is determined iteratively by the class similarity ratio between the two classes. The pixel is assigned to the class prototype at the denominator if the class similarity ratio exceeds a threshold. The threshold is adapted to the subregions of the lungs as defined in step 70. The centroid of a class prototype is updated (recomputed) after each iteration when all pixels in the region of interest have been assigned a membership. The whole process of membership assignment will then be repeated using the updated centroids. The iteration is terminated when the changes in the class centroids fall below a predetermined threshold or when no new members are assigned to a class. At this point, the member pixels of the two class prototypes are finalized and the potential nodules and the background lung tissue structures defined.

If desired, relatively lax parameters can be used in the pixel similarity analysis algorithm so that the majority of true lung nodules will be detected. The pixel similarity analysis algorithm may use features such as the CT number, the smoothed image gradient magnitudes, and the median value in a k by k region around a pixel as components in the feature vector. The two latter features allows the pixel to be classified not only on the basis of its CT number, but also on the local image context. The median filter size and the degree of smoothing can also be altered to provide better detection. If desired, a bank of filters matched to different sphere radii (i.e., distance from the pixel of interest) may be used to perform detection of nodule candidates. Likewise, the number and size of detected objects can be controlled by changing the threshold for the class similarity ratio in the algorithm, which is the ratio of the Euclidean distances between the feature vector of a given pixel and the centroids of each of the two class prototypes.

Furthermore, it is known that the characteristics of normal structures, such as blood vessels, depend on their location in the lungs. For example, the vessels in the middle lung region tend to be large and intersect the slices at oblique angles while the vessels in the upper lung regions are usually smaller and tend to intersect the slices more perpendicularly. Likewise, the blood vessels are densely distributed near the center of the lung and spread out towards the periphery of the lung. As a result, when a single class similarity ratio threshold is used for detection of potential nodules in the upper, middle, and lower regions of the thorax, the detected objects in the upper part of the lung are usually more numerous but smaller in size than those in the middle and lower parts. Also, the detected objects in the central region of the lung contain a wider range of sizes than those in the peripheral regions. In order to effectively reduce the detection of false positive objects (i.e., objects that are not actual nodules), different filtered images or combinations of filtered images and different thresholds may be defined for the pixel similarity analysis technique described above for each of the different subregions of the lungs, as defined by the step 70. For example, in the lower and upper regions of the lungs, the thresholds or weights used in the pixel similarity analysis described above may be adjusted so that the segmentation of some non-nodule, high-density regions along the periphery of the lung can be minimized. In any event, the best criteria that maximizes the detection of true nodules and that minimizes the false positives may change from lung region to lung region and, therefore, may be selected based on the lung regions in which the detection is occurring. In this manner, different feature vectors and class similarity ratio thresholds may be used in the different parts of the lungs to improve object detection but reduce false positives.

Of course, it will be understood that the pixel similarity analysis technique described herein may be performed individually on each of the different CT scan image slices and may be limited to the regions of those images defined as the lungs by the segmentation procedures performed by the steps 62-74. Furthermore, the output of the pixel similarity analysis algorithm is generally a binary image having pixels assigned to the background or to the object class. Due to the segmentation process, some of the segmented binary objects may contain holes. Because the nodule candidates will be treated as solid objects, the holes within the 2D binary images of any object are filled using a known flood-fill algorithm, i.e., one that assigns background pixels contained within a closed boundary of object pixels to the object class. The identified objects are then stored in, for example, one of the files 50 of FIG. 1 in any desired manner and these objects define the set of prescreened nodule candidates to be later processed as potential nodules.

9. Elimination of Vascular Objects

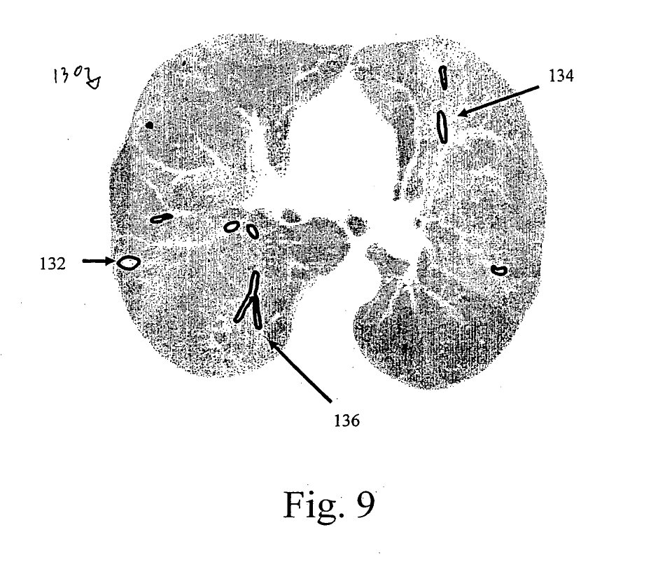

After a set of preliminary nodule candidates have been identified by the step 76, a step 78 may perform some preliminary processing on these objects in an attempt to eliminate vascular objects (which will be responsible for most false positives) from the group of potential nodule candidates. FIG. 9 illustrates segmented structures for a sample CT slice 130. In this slice, a true lung nodule 132 is segmented along with normal lung structures (mainly blood vessels) 134 and 136 with high intensity values.

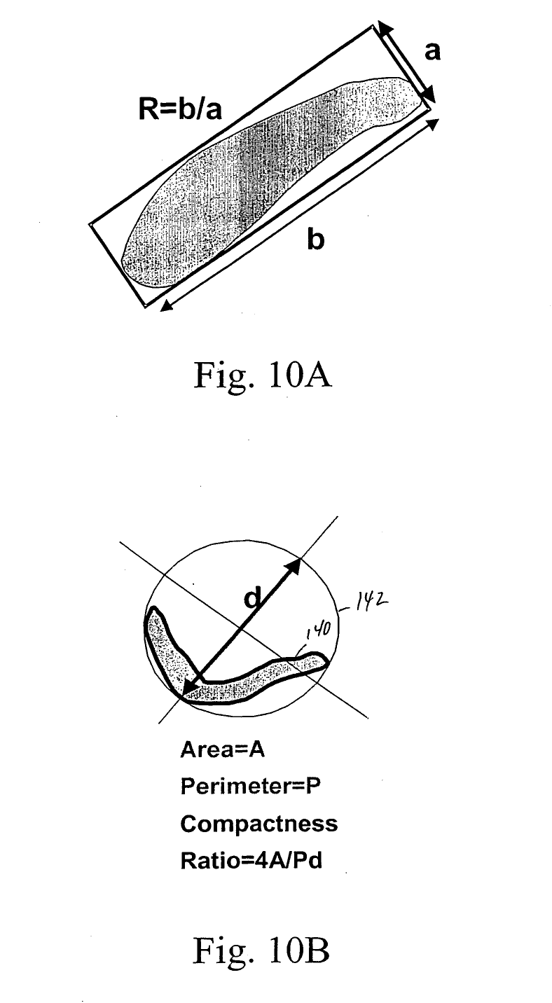

In most cases it is possible to reduce the number of segmented blood vessel objects based on their morphology. The step 78 may employ a rule-based classifier (such as one of the classifiers 42 of FIG. 1) to distinguish blood vessel structures from potential nodules. Of course, any rule-based classifiers may be applied to image features extracted from the individual 2D CT slices to detect vascular structures. One example of a rule-based classifier that may be used is intended to distinguish thin and long objects, which tend to be vessels, from lung nodules. The object 134 of FIG. 9 is an example of such a long, thin structure. According to this rule, and as illustrated in FIG. 10A, each segmented object is enclosed by the smallest rectangular bounding box and the ratio R of the long (b) to the short (a) side length of the rectangle, is calculated. When the ratio R exceeds a chosen threshold and the object is therefore long and thin, the segmented object is considered to be a blood vessel and is eliminated from further processing as a nodule candidate.

Likewise, a second rule-based classifier that may be used attempts to identify object structures that have Y-shapes or branching shapes, which tend to be branching blood vessels. The object 136 of FIG. 9 is such a branching-shaped object. This second rule-based classifier uses a compactness criterion (the compactness of an object is defined as the ratio of its area to perimeter, A/P. The compactness of a circle, for example, is 0.25 times the diameter. The compactness ratio is defined as the ratio of the compactness of an object to the compactness of a minimum-size circle enclosing the object) to distinguish objects with low compactness from true nodules that are generally more round. Such a compactness criterion is illustrated in FIG. 10B in which the compactness ratio is calculated for the object 140 relative to that of the circle 142. Whenever the compactness ratio is lower than a chosen or preselected threshold, it has a desired degree of branching shape and the object is considered to be a blood vessel and can be eliminated from further processing.

Although two specific shape criteria are discussed here, there are alternative shape descriptors that may be used as criteria to distinguish branching shaped object and round objects. One such criterion is the rectangularity criterion (the ratio of the area of the segmented object to the area of its rectangular bounding box). Another criterion is the circularity criterion (the ratio of the area of the segmented object to the area of its bounding circle). A combination of one or more of these criteria may also be useful for excluding vascular structures from the potential nodule pool.

After these rules are applied, the remaining 2D segmented objects are grown into three-dimensional objects across consecutive CT scan image slices using a 26-connectivity rule. As discussed above, in 26-connectivity, a voxel B is connected to a voxel A if the voxel B is any one of the 26 neighboring voxels on a 3×3×3 cube centered at voxel A.

False positives may further be reduced using classification rules regarding the size of the bounding box, the maximum object sphericity, and the relation of the location of the object to its size. The first two classification rules dictate that the x and y dimensions of the bounding box enclosing the segmented 3D object has to be larger than 2 mm in each dimension. The third classification rule is based on sphericity (defined as ratio of the volume of the 3D object to the volume of a minimum-sized sphere enclosing the object) because the nodules are expected to exhibit some sphericity. The third rule requires that the maximum sphericity of the cross sections of the segmented 3D object among the slices containing the object must be greater than a threshold, such as 0.3. The fourth rule is based on the knowledge that the vessels in the central lung regions are generally larger in diameter than vessels in the peripheral lung regions. A decision rule is designed to eliminate lung nodule candidates in the central lung region that are smaller than a threshold, such as smaller than 3 mm in the longest dimension. Of course, other 2D and 3D rules may be applied to eliminate vascular or other types of objects from consideration as potential nodules.

10. Shape Improvement in 2D and 3D

After the vascular objects have been reduced or eliminated at the step 78, a step 80 of FIG. 2 performs shape improvement on the remaining objects (as detected by the step 76 of FIG. 2) to enable enhanced classification of these objects. In particular, if not already performed, the step 80 forms 3D objects for each of the remaining potential candidates and stores these 3D objects in, for example, one of the files 50 of FIG. 1. The step 80 then extracts a number of features for each 3D object including, for example, volume, surface area, compactness, average gray value, standard deviation, skewness and kurtosis of the gray value histogram. The volume is calculated by counting the number of voxels within the object and multiplying this by the unit volume of a voxel. The surface area is also calculated in a voxel-by-voxel manner. Each object voxel has six faces, and these faces can have different areas because of the anisotropy of CT image acquisition. For each object voxel, the faces that neighbor non-object voxels are determined, and the areas of these faces are accumulated to find the surface area. The object shape after pixel similarity analysis tends to be smaller than the true shape of the object. For example, due to partial volume effects, many vessels have portions with different brightness levels in the image plane. The pixel similarity analysis algorithm detects the brightest fragments of these vessels, which tend to have rounder shapes instead of thin and elongated shapes. To refine the object boundaries on a 2D slice, the step 80 can follow pixel similarity analysis by iterative object growing for each object. At each iteration, the object gray level mean, object gray level variance, image gray level and image gradients can be used to determine if a neighboring pixel should be included as part of the current object.

Likewise, after the segmentation techniques described above in 2D are performed on the different CT scan image slices independently, the step 80 uses the objects detected on these different slices to define 3D objects based on generalized pixel connectivity. The 3D shapes of the nodule candidates are important for distinguishing true nodules and false positives because long vessels that mimic nodules in a cross sectional image will reveal their true shape in 3D. To detect connectivity of pixels in three dimensions, 26-connectivity as described above in step 64 may be used. However, other definitions of connectivity, such as 18-connectivity or 6-connectivity may also be used.

In some cases, even 26-connectivity may fail to connect some vessel segments that are visually perceived to belong to the same vessel. This occurs when thick axial planes intersect a small vessel at a relatively large oblique angle resulting in disconnected vessel cross-sections in adjacent slices. To overcome this problem, a 3D region growing technique combined with 2D and 3D object features in the neighboring slices may be used to establish a generalized connectivity measure. For example, two objects, thought to be vessel candidates in two neighboring slices, can be merged into one object if the objects grow together when the 3D region growing is applied, the two objects are within a predetermined distance of each other; and the cross section area, shape, the gray-level standard deviation and the direction of the major axis of the objects are similar.

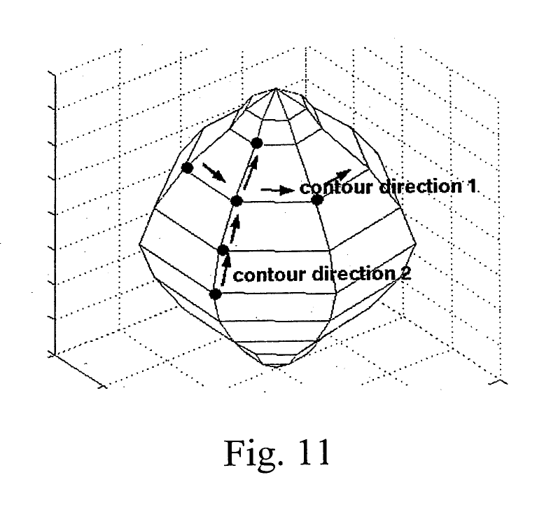

As an alternative to region growing, an active contour model may be used to improve object shape in 3D or to separate a nodule-like branch from a connected vessel. With the active contour technique, an initial nodule outline is iteratively deformed so that an energy term containing components related to image data (external energy) and a-priori information on nodule characteristics (internal energy) is minimized. This general technique is described in Kass et al., “Snakes: Active Contour Models,” Int J Computer Vision 1, 321-331 (1987). The use of a-priori information prevents the segmented nodule from attaining unreasonable shapes, while the use of the energy terms related to image data attracts the contour to object boundaries in the image. This property can be used to prevent a vessel from being attached to a nodule by controlling the smoothness of the contour with the use of an a-priori weight for boundary smoothness. The external energy components may include the edge strength, directional gradient measure, the local averages inside and outside the boundary, and other features that the curvature, elasticity and the stiffness of the boundary. A 2D active contour module may be generalized to 3D by considering contours on two perpendicular planes. Such a 3D contour model is illustrated in FIG. 11, which depicts an object that is grown in 3D by connecting points or pixels in each of a number of different image planes or CT images. As illustrated in FIG. 11, these connections can be performed in two directions (i.e., within a CT image plane and between adjacent CT image planes). The 3D active contour method combines the contour continuity and curvature parameters on two or more different groups of 2-D contours. By minimizing the total curvature of these contours, the active contour method tends to segment an object with a smooth 3D shape. This a-priori tendency is balanced by an a-posteriori force that moves the vertices towards high 3D image gradients. The continuity term assures that the vertices are uniformly distributed over the volume of the 3D object to be segmented.

In any event, after the step 80 performs shape enhancement on each of the remaining objects in both two and three dimensions, the set of nodules candidates 82 (of FIG. 1) are established. Further processing on these objects can then be performed as described below to determine if these nodules candidates are, in fact, lung cancer nodules and, if so, are the lung cancer nodules benign or malignant.

11. Nodule Candidate Classification

Once nodule candidates have been identified, the block 84 differentiates true nodules from normal structures. The nodule segmentation routine 37 is used to invoke an object classifier 43, such as, a neural network, a linear discriminant analysis (LDA), a fuzzy logic engine, combinations of those, or any other expert engine known to those of ordinary skill in the art. The object classifier 43 may be used to further reduce the number of false positive nodule objects. The nodule segmentation routine 37 provides the object classifier 43 with a plurality of object features from the object feature classifier 42. With respect to differentiating true nodules from normal pulmonary structures, the normal structures of main concern are generally blood vessels, even though many of the objects will have been removed from consideration by initially detecting a large fraction of the vascular tree. Based on knowledge of the differences in the general characteristics between blood vessels and nodules, certain classification rules are designed to reduce false-positives. These classification rules are stored within the object feature classifier 42. In particular, (1) nodules are generally spherical (circular on the cross section images), (2) convex structures connecting to the pleura are generally nodules or partial volume artifacts, (3) blood vessels parallel to the CT image are generally elliptical in shape and may be branched, (4) blood vessels tend to become smaller as their distances from the mediastinum increase, (5) gray values of vertically running vessels in a slice are generally higher than a nodule of the same diameter, and (6) when the structures are connected across CT sections, vessels in 3D tend to be long and thin.

As discussed above, the features of the objects which are false positives may depend on their locations in the lungs and, thus, these rules may be applied differently depending on the region of the lung in which the object is located. However, the general approaches to feature extraction and classifier design in each sub-region are similar and will not be described separately.

(a) Feature Extraction From Segmented Structures in 2D and 3D

Feature descriptors can be used based -on pulmonary nodules and structures in both 2D and 3D. The nodule segmentation routine 37 may obtain from the object feature classifier 42 a plurality of 2D morphological features that can be used to classify an object, including: shape descriptors such as compactness (the ratio of number of object area to perimeter pixels), object area, circularity, rectangularity, number of branches, axis ratio and eccentricity of an effective ellipse, distance to the mediastinum and distance to the lung wall. The nodule segmentation routine 37 may also obtain 2D gray-level features that include: the average and standard deviation of the gray levels within the structure, object contrast, gradient strength, the uniformity of the border region, and features based on the gray-level-weighted distance measure within the object. In general, these features are useful for reducing false positive detections and, additionally, are useful for classifying malignant and benign nodules. Classifying malignant and benign nodules will be discussed in more detail below.

Texture measures of the tissue within and surrounding an object are also important for distinguishing true and false nodules. It is known to those of ordinary skill in the art that texture measures can be derived from a number of statistics such as, for example, the spatial gray level dependence (SGLD) matrices, gray-level run-length matrices, and Laws textural energy measures which have previously been found to distinguish mass and normal tissue on mammograms.

Furthermore, the nodule segmentation routine 37 may direct the object classifier 43 to use 3D volumetric information to extract 3D features for the nodule candidates. After the segmentation of objects in the 2D slices and the region growing or 3D active contour model to establish the connectivity of the objects in 3D, the nodule segmentation routine 37 obtains a plurality of 3D shape descriptors of the objects being analyzed. The 3D shape descriptors include, for example: volume, surface area, compactness, convexity, axis ratio of the effective ellipsoid, the average and standard deviation of the gray levels inside the object, contrast, gradient strength along the object surface, volume to surface ratio, and the number of branches within an object can be derived. 3D features can also be derived by combining 2D features of a connected structure in the consecutive slices. These features can be defined as the average, standard deviation, maximum or minimum of a feature from the slices comprising the object.

Additional features describing the surface or the region surrounding the object such as roughness and gradient directions, and information such as the distance of the object from the chest wall and its connectivity with adjacent structures may also be used as features to be considered for classifying potential nodules. A number of these features are effective in differentiating nodules from normal structures. The best features are selected in the multidimensional feature space based on a training set, either by stepwise feature selection or a genetic algorithm. It should also be noted that for practical reasons, it may be advantageous to eliminate all structures that are less than a certain size, such as, for example, less than 2 mm.

(b) Design of Feature Classifiers for Differentiation of True Nodules and Normal Structures

As discussed above, the object classifier 43 may include a system implementing a rule-based method or a system implementing a statistical classifier to differentiate nodules and false positives based on a set of extracted features, The disclosed example combines a crisp rule-based classifier with linear discriminant analysis (LDA). Such a technique involves a two-stage approach. First, the rule-based classifier eliminates false-positives using a sequence of decision rules. In the second-stage classification, a statistical classifier or ANN is used to combine the features linearly or non-linearly to achieve effective classification. The weights used in the combination of features are obtained by training the classifiers with a large training set of CT cases.

Alternatively, a fuzzy rule-based classifier or any other expert engine, instead of a crisp rule-based classifier, can be used to pre-screen the false positives in the first stage and a statistical classifier or an artificial neural network (ANN) is trained to distinguish the remaining structures as vessels or nodules in the second stage. This approach combines the advantages of fuzzy classification that uses knowledge-based image characteristics as performed visually by expert radiologists, emulates the non-crisp human decision process, and is more tolerant of imprecise data, and a complex statistical or ANN classification in the high dimensional feature space that is not perceivable by human observers. The membership functions and fuzzy classification rules are designed based on expert knowledge on the lung nodules and the extracted features describing the image characteristics.

12. Nodule classification

After it is determined by the nodule classification routine 84 that the nodules at a block 86 are true nodules, a block 88 of FIG. 2 may be used to classify the nodules as being either benign or malignant. Two types of characterization tasks can be used including characterization based on a single exam and characterization based on multiple exams separated in time for the same patient. The classification routine 38 invokes the object classifier 43 to determine if the nodules are benign or malignant, such as estimating a likelihood of malignancy for each nodule, based on a plurality of features associated with the nodule that are found in the object feature classifier 42 as well as other features specifically designed for malignant and benign classification.

The classification routine 38 may be used to perform interval change analysis where repeat CTs are available. It is known to those of ordinary skill in the art that the growth rate of a cancerous nodule is a very important feature related to malignancy. As an additional application, the interval change analysis of nodule volume is also important for monitoring the patient's response to treatment such as chemotherapy or radiation therapy since the cancerous nodule may reduce in size if it responds to treatment. This technique is accomplished by extracting a feature related to the growth rate by comparing the nodule volumes on two exams.

The doubling time of the nodule is estimated based on the nodule volume at each exam and the number of days between the two exams. The accuracy of the nodule volume estimation and its dependence on nodule size and imaging parameters may be established by a variety of factors. The volume is automatically extracted by 3D region growing or active contour models, as described above. Analysis indicates that combinations of current, prior, and difference features of a mass improve the differentiation of malignant and benign lesions.

The classification routine 38 causes the object classifier 43 to evaluate different similarity measures of two feature vectors that include the Euclidean distance, the scalar product, the difference, the average and the correlation measures between the two feature vectors. These similarity measures, in combination with the nodule features extracted from the current and prior exams, will be used as the input predictor variables to a classifier, such as an artificial neural network (ANN) or a linear discriminant classifier (LDA), which merge the interval change information with image feature information to differentiate malignant and benign nodules. The weights for merging the information are obtained from training the classifier with a training set of CT cases.

The process of interval change analysis may be fully automated or the process may include manually identifying corresponding nodules on two separate scans. Automated identification of corresponding nodules requires 3D registration of serial CT images and, likely, subsequent local registration of nodules because of the possible differences in patient positioning, and respiration phase, etc, from one exam to another. Conventional automated methods have been developed to register multi-modality volumetric data sets by optimization of the mutual information using affine and thin plate spline warped geometric deformations.

In addition to the image features described above, many factors are related to risk of lung cancers. These factors include, for example: age, smoking history, and previous malignancy. Data related to these risk factors combined with image features may be compared to image feature based classification. This may be accomplished by coding the risk factors as input features to the classifiers.

Different types of classifiers may be used, depending on whether repeat CT exams are available. If the nodule has not been imaged serially, single CT image features are used either alone or in combination with other risk factors for classification. If repeat CT is available, additional interval change features are included. A large number of features are initially extracted from nodules. The most effective feature subset is selected by applying automated optimization algorithms such as genetic algorithm (GA) or stepwise feature selection. ANN and statistical classifiers are trained to merge the selected features into a malignancy score for each nodule. Fuzzy classification may be used to combine the interval change features with the malignancy score obtained from the different CT scans, described above. For example, growth rate is divided into at least four fuzzy sets (e.g., no growth, moderate, medium and high growth). The malignancy score from the latest CT exam is treated as the second input feature into the fuzzy classifier, and is divided into at least three fuzzy sets. Fuzzy rules are defined to merge these fuzzy sets into a classifier score.

As part of the characterization, the classification routine 38 causes the morphological, texture, and spiculation features of the nodules to be extracted and includes both 2D and 3D features. For texture extraction, the ROIs are first transformed using the rubber-band straightening transform (RBST), which transforms a band of pixels surrounding a lesion to a 2D rectangular coordinate system, as described in Sahiner et al., “Computerized characterization of masses on mammograms: the rubber band straightening transform and texture analysis,” Medical Physics, 1998, 25:516-526. The RBST is generalized to 3D for CT volumetric images. In 3D, a shell of voxels surrounding the nodule surface is transformed to a rectangular layer of voxels in a 3D orthogonal coordinate system. Thirteen spatial gray-level dependence (SGLD) feature measures, and five run length statistics (RLS) measures may be extracted. The extracted RLS and SGLD features are both 2D and 3D. Spiculation features are extracted using the statistics of the image gradient direction relative to the normal direction to the nodule border in a ring of pixels surrounding the nodule. The extraction of spiculation feature is based on the idea that the direction of the gradient at a pixel location p is perpendicular to the normal direction to the nodule border if p is on a spiculation. This idea was used for deriving a spiculation feature for 2D images in Sahiner et al, “Improvement of mammographic mass characterization using spiculation measures and morphological features,” Medical Physics, 2001, 28(7): 1455-1465. A generalization of this method to 3D is used for lung nodule, analysis such that in 3D, the gradient at a voxel location v will be parallel to the tangent plane of the object if the v is on a spiculation. Stepwise feature selection with simplex optimization may be used to select the optimal feature subset. An LDA classifier designed with a leave-one-case-out training and testing re-sampling scheme can be used for feature selection and classification.

Another feature analyzed by the object classifier is the blood flow to the nodule. Malignant nodules have higher blood flow and vascularity that contribute to their greater enhancement. Because many nodules are connected to blood vessels, vascularity can be used as a feature in malignant and benign classification. As described in the segmentation step 84, vessels connected to nodules are separated before morphological features are extracted. However, the connectivity to vessels is recorded as a vascularity measure, for example, the number of connections.

A distinguishing feature of benign pulmonary nodules is the presence of a significant amount of calcifications with central, diffuse, laminated, or popcorn-like patterns. Because calcium absorbs x-rays considerably, it often can be readily detected in CT images. The pixel values (CT#s) of tissues in CT images are related to the relative x-ray attenuation of the tissues. Ideally, the CT# of a tissue should depend only on the composition of the tissue. However, many other factors affect the CT#s including x-ray scatter, beam hardening, and partial volume effects. These factors cause errors in the CT#s, which can reduce the conspicuity of calcifications in pulmonary nodules. The CT# of simulated nodules is also dependent on the position in the lungs and patient size. One way to counter these effects is to relate the CT#s in a patient scan to those in an anthropomorphic phantom. A reference phantom technique may be implemented to compare the CT#s of patient nodules to those of matching reference nodules that are scanned in a thorax phantom immediately after each patient. A previous study compared the accuracy of the classification of calcified and non-calcified solitary pulmonary nodules obtained with standard CT, thin-section CT, and reference phantom CT). The study found that the reference phantom technique was best. Its sensitivity was 22% better than thin section CT, which was the second best technique.

The automatic classification of lung nodules as benign or malignant by CAD techniques could benefit from data obtained with reference phantoms. However, the required scanning of a reference phantom after each patient would be impractical. As a result, an efficient new reference phantom paradigm can be used in which measured CT#s of reference nodules of known calcium carbonate content are employed to determine sets of calibration lines throughout the lung fields covering a wide variety of patient conditions. Because of the stability of modern CT scanners, a full set of calibration lines need to be generated only once, with spot checks performed at subsequent intervals. The calibration lines are similar to those employed to compute bone mineral density in quantitative CT. Sets of lines are required because the effective beam energy varies as a function of position within the lung fields and the CT# of CaCO₃ is highly dependent upon the effective energy.

The classification routine 38 extracts the detailed nodule shape by using active contour models in both 2D and 3D. For the automatically detected nodules, refinement from the segmentation obtained in the detection step is needed for classification of malignant and benign nodules because features comparing malignant and benign nodules are more similar than those comparing nodule and normal lung structures. The 3D active contour method for refinement of the nodule shape has been described above in step 80.

The refined nodule shape in 2D and 3D is used for feature extraction, as described below, and volume measurements. Additionally, the volume measurements can be displayed directly to the radiologist as an aid in characterizing nodule growth in repeat CT exams.

The fact that radiologists use features on CT slice images for the estimation of nodule malignancy indicates that 2D features are discriminatory for this task. For nodule characterization from a single CT exam, the following features are used: (i) morphological features that describe the size, shape, and edge sharpness of the, nodules extracted from the nodule shape segmented with the active contour models; (ii) nodule spiculation; (iii) nodule calcification; (iv) texture features; and (v) nodule location. Morphological features include descriptors such as compactness, object area, circularity, rectangularity, lobulation, axis ratio and eccentricity of an effective ellipse, and location (upper, middle, or lower regions in the thorax). 2D gray-level features include features such as the average and standard deviation of the gray levels within the structure, object contrast, gradient strength, the uniformity of the border region, and features based on the gray-level-weighted distance measure within the object. Texture features include the texture measures derived from the RLS and SGLD. matrices. It is found that particular useful RLS features are Horizontal and Vertical Run Percentage, Horizontal and Vertical Short Run Emphasis, Horizontal and Vertical Long Run Emphasis, Horizontal Run Length Nonuniforminty, Horizontal Gray Level Nonuniformity. Useful SGLD features include Information Measure of Correlation, Inertia, Difference Variation, Energy, and Correlation and Difference Average. Subsets of these textures features, in combination with the other features described above will be the input variables to the feature classifiers. For example, using the area under the receiver operating characteristic curve, Az, as the accuracy measure, it is found that:

Furthermore, useful in one example, combination of features for classification of 61 nodules (37 malignant and 24 benign) included:
Information Measure of Correlation and Inertia−Az=0.805
Information Measure of Correlation and Difference Average−Az=0.806
Useful combination of features for classification on 41 temporal pairs of nodules (32 malignant and 9 benign) included the use of RLS and SGLD features, which are difference features obtained by subtraction of the prior feature from the current feature. In this case, the following combinations of features were used.
Horizontal Run Percentage, Horizontal Short Run Emphasis, Horizontal Long Run Emphasis, Vertical Long Run Emphasis−Az=0.85
Horizontal Run Percentage, Difference Variation, Energy, Correlation, Horizontal Short Run Emphasis, Horizontal Long Run Emphasis, Information Measure of Correlation−Az=0.895
Horizontal Run Percentage, Volume, Horizontal Short Run Emphasis, Horizontal Long Run Emphasis, Vertical Long Run Emphasis−Az=0.899

To characterize the spiculation of a nodule, the statistics of the image gradient direction relative to the normal direction to the nodule border in a ring of pixels surrounding the nodule is analyzed. The analysis of spiculation in 2D is found to be useful for classification of malignant and benign masses on mammograms in our breast cancer CAD system. The spiculation measure is extended to 3D for lung cancer detection. The measure of spiculation in 3D is performed in two ways. First, the statistics, such as the mean and the maximum of the 2D spiculation measure, are combined over the CT slices that contain the nodule. Second, for cases with thin CT slices, e.g. 1 mm or 1.25 mm thick, 3D gradient direction and normal direction to the surface in 3D is computed and used for spiculation detection. The normal direction in 3D is computed based on the 3D geometry of the active contour vertices. The gradient direction is computed for each image voxel in a 3D hull with a thickness of T around the object. For each voxel on the 3D object surface, the angular difference between the gradient direction and the surface-voxel-to-image-voxel direction is computed. The distribution of these angular differences obtained from all image voxels spanning a 3D cone centered around the normal direction at the surface voxel are obtained. Similar to 2D spiculation detection, if a spiculation points towards the surface voxel, then there is a peak in this distribution at an angle of 0 degrees. The extraction of spiculation features from this distribution will be based on the 2D technique.

13. Display of Results

After the step 88 of FIG. 2 has identified, for each detected nodule 86, whether the nodule is benign or malignant, such as estimating the likelihood of being malignant for the nodule, a step 90, which may use the display routine 52 of FIG. 1, displays the results of the nodule detection and classification steps to a user, such as a radiologist, for use by the radiologist in any desired manner. Of course the results may be displayed to the radiologist in any desired manner that makes it convenient for the radiologist to see the detected nodules and the suggested classification of these nodules. In particular, the step 90 may display one or more CT image scans illustrating the detected nodules (which may be highlighted, circled, outlined, etc.) and may indicate next to the detected nodule whether the nodule has been identified as benign or malignant, or a percent chance of being malignant. If desired, the radiologist may provide input to the computer system 22, such as via a keyboard or a mouse, to prompt the radiologist with the detected nodules (but without any determined malignancy or benign classification) and may then again prompt the computer a second time for the malignancy or benign classification information. In this manner, the radiologist may make an independent study of the CT scans to detect nodules (before viewing the computer generated results) and may make and an independent diagnosis as to the nature of the detected nodules (before being biased by the computer generated results). Likewise, the radiologist may view one or more CT scans without the computer performing any nodule detection and may circle or identify a potential nodule for the computer using, for example, a mouse, light pen, etc. Thereafter, the computer may identify the object specified by the radiologist (i.e., perform 2D and 3D detection and processing of the object) and may then determine if the object is a nodule or may determine if the object is benign or malignant using the techniques described above. Of course, any other manner of presenting indications of the detected nodules and their classifications, such as a 3D volumetric display or a maximum intensity display of the CT thoracic image superimposed with the detected nodule locations, etc., may be provided to the user.

In one embodiment, the display environment may be in a different computer than that used for the nodule detection and diagnosis. In this case, after automated detection and classification, the CT study and the computer detected nodule locations can be downloaded to the display station. The user interface may contain menus to select functions in the display mode. The user can display the entire CT study in a cine loop or use a manual controlled slice-by-slice loop. The images can be displayed with or without the computer detected nodule locations superimposed. The estimated likelihood of malignancy of a nodule can also be displayed, depending on the application. Image manipulation such as windowing and zooming can also be provided.

Still further, for the purpose of performance evaluation, the radiologist may enter a confidence rating on the presence of a nodule, mark the location of the suspicious lesion on an image, and input his/her estimated likelihood of malignancy for the identified lesion. The same input functions will be available for both the with- and without-CAD readings so that the radiologist's reading with- and without-CAD can be recorded and compared if desired.

When implemented, any of the software described herein may be stored in any computer readable memory such as on a magnetic disk, an optical disk, or other storage medium, in a RAM or ROM of a computer or processor, etc. Likewise, this software may be delivered to a user or a computer using any known or desired delivery method including, for example, on a computer readable disk or other transportable computer storage mechanism or over a communication channel such as a telephone line, the Internet, the World Wide Web, any other local area network or wide area network, etc. (which delivery is viewed as being the same as or interchangeable with providing such software via a transportable storage medium). Furthermore, this software may be provided directly without modulation or encryption or may be modulated and/or encrypted using any suitable modulation carrier wave and/or encryption technique before being transmitted over a communication channel.

While the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

1. A method of identifying a left lung region and a right lung region on one or more computed tomography (CT) images comprising:
identifying a first set of pixels associated with a first largest airspace on the CT image; the first set of pixels defining one of the left lung region and the right lung region;
identifying a second set of pixels associated with a second largest airspace on the CT image; the second set of pixels defining one of the left lung region and the right lung region not defined by the first set of pixels; and
storing an identification of the first and second set of pixels in a memory as the left and right lung regions.

2. The method of claim 1, including identifying an anterior junction line for separating the left lung region and the right lung region.

3. The method of claim 1, including setting a threshold value for the first largest airspace and the second largest airspace to eliminate a trachea or an esophagus from consideration as the left lung region or the right lung region.

4. The method of claim 1, including calculating a ratio of the size defined by the first set of pixels to the second set of pixels.

5. The method of claim 1, including comparing the ratio to a predetermined threshold to determine if both the left lung region and the right lung region are present on the image scan.

6. A method of identifying a left lung region and a right lung region on a computed tomography (CT) image comprising:
identifying a lung structure on the CT image;
determining a centroid of the identified lung structure;
determining a location of the centroid on the CT image; and
classifying the lung structure based on the location of the centroid on the CT image as including both the left and right lung regions or only one of the left and right lung regions.

7. The method of claim 6, including classifying the lung structure including both the left lung region and the right lung region if the centroid is substantially located at a center of the CT image.

8. The method of claim 7, including determining if the lung structure includes a first wide portion, a second wide portion, and a narrow portion between the first and second wide portions.

9. The method of claim 8, including splitting the lung structure through the narrow portion to separate the left lung region from the right lung region.

10. The method of claim 9, wherein splitting the lung structure includes using a minimum cost splitting technique.

11. The method of claim 6, including identifying and tracking a trachea in three dimensions to eliminate the trachea from consideration as a lung structure.

12. The method of claim 6, including classifying the lung structure as only the left lung if the centroid of the lung structure is located a predetermined number of pixels to the left of the center of the CT image and classifying the lung structure as only the right lung if the centroid of the lung structure is located a predetermined number of pixels to the right of the center of the CT image.

13. A method of partitioning a lung on one or more computed tomography (CT) images into a plurality of subregions, comprising:
identifying a first set of pixels associated with the lung on the CT images;
identifying a subset of pixels on the CT images associated with an inner wall and an outer wall of the lung;
identifying an interior pixel within the lung, the interior pixel not being one of the subset of pixels;
calculating a first distance between the interior pixel and a closest first pixel on the inner wall and a second distance between the interior pixel and a closest second pixel on the outer wall;
determining a ratio between the first distance and the second distance; and
categorizing the interior pixel as one of the plurality of subregions based on the ratio.

14. The method of claim 13, including partitioning the lung into a central subregion, an intermediate subregion, and a peripheral subregion.

15. A method of segmenting a passage in a set of computed tomography (CT) images, comprising:
(a) identifying a region of interest on a CT image;
(b) defining a passage centroid for a passage class of pixels and a background centroid for a background class of pixels in the region of interest on the CT image based on two or more versions of the CT image;
(c) determining a passage distance between a pixel and the passage centroid and a background distance between the pixel and the background centroid; and
(d) assigning the pixel to the passage class or to the background class based on the first and second distances.

16. The method of claim 15, wherein defining the passage and the background centroids includes using the CT image and a filtered version of the CT image.

17. The method of claim 16, wherein the filtered version of the CT image is selected from the group of filtered image scans consisting of: a median filter, a gradient filter, and a maximum intensity projection filter.

18. The method of claim 15, including repeating steps of (c) and (d) for each pixel in the region of interest on the CT image.

19. The method of claim 18, including redefining the passage centroid and the background centroid after each pixel in the region of interest on the CT image has been assigned to the passage class or to the background class and repeating steps (c) and (d) for each pixel in the CT image.

20. The method of claim 15, wherein assigning the pixel to the passage class or to the background class includes determining a similarity measure from the passage distance and the background distance and comparing the similarity measure to a threshold.

21. The method of claim 15, including separating a lung region from the passage using a K-means clustering technique.

22. The method of claim 21, including implementing a three-dimensional region growing algorithm to track a trachea or a bronchi within the lung region

23. The method of claim 22, wherein implementing the growing algorithm includes tracing the trachea or the bronchi using 26 point spatial connectivity.

24. The method of claim 22, wherein implementing the growing algorithm includes tracking the trachea or bronchi using pixel gray-level continuity.

25. The method of claim 22, wherein implementing the growing algorithm includes tracking the trachea or bronchi using an expected curvature and diameter of the trachea or bronchi.

26. The method of claim 15, wherein the passage is a trachea.

27. The method of claim 15, wherein the passage is a bronchi.

28. The method of claim 15, wherein the passage is an esophagus.

29. A method of identifying a potential lung nodule comprising:
(a) identifying a region of interest on a computed tomography (CT) image;
(b) defining a nodule centroid for a nodule class of pixels and a background centroid for a background class of pixels within the region of interest in the CT image based on two or more versions of the CT image;
(c) determining a nodule distance between a pixel and the nodule centroid and a background distance between the pixel and the background centroid; and
(d) assigning the pixel to the nodule class or to the background class based on the first and second distances.

30. The method of claim 29, wherein defining the nodule and the background centroids includes using the CT image and a filtered version of the CT image.

31. The method of claim 30, wherein the filtered version of the CT image is selected from the group of filtered image scans consisting of: a median filter, a gradient filter, and a maximum intensity projection filter.

32. The method of claim 29, including identifying a subregion of the lung as the region of interest.

33. The method of claim 29, including repeating steps of (c) and (d) for each pixel in the region of interest.

34. The method of claim 33, including redefining the nodule centroid and the background centroid after each pixel in the region of interest has been assigned to the nodule class or to the background class and repeating steps (c) and (d) for each pixel in the region of interest.

35. The method of claim 29, wherein assigning the pixel to the nodule class or to the background class includes determining a similarity measure from the nodule distance and the background distance and comparing the similarity measure to a threshold.

36. The method of claim 29, including defining a nodule as a group of connected pixels assigned to the nodule class to form a solid object and filling in a hole in the solid object using a flood-fill technique.

37. The method of claim 29, including storing an identification of the pixel if assigned to the nodule class in a memory.

38. A method for differentiating a lung nodule from a normal lung structure using one or more computed tomography (CT) images, comprising:
identifying a potential lung nodule from the CT images;
extracting a two-dimensional feature associated with the potential lung nodule;
extracting a three-dimensional feature associated with the potential lung nodule; and
invoking an expert engine to analyze the two-dimensional and the three-dimensional features to determine if the potential lung nodule is the lung nodule- or the normal lung structure.

39. The method of claim 38, wherein invoking an expert engine includes invoking a neural network to determine if the potential lung nodule is the lung nodule or the normal lung structure.

40. The method of claim 38, wherein invoking an expert engine includes invoking a crisp rule-based classifier and a linear discriminant analyzer to determine if the potential lung nodule is the lung nodule or the normal lung structure

41. The method of claim 38, wherein the two-dimensional feature is selected from the group of two-dimensional features consisting of: compactness, object area, circularity, rectangularity, number of branches, axis ratio, eccentricity of an effective ellipse, distance to a mediastinum, distance to a chest wall, average of gray level, standard deviation of gray level, object contrast, gradient strength, uniformity of a border region, and gray-level-weighted distance measure.

42. The method of claim 38,, wherein the three-dimensional feature is selected from the group of three-dimensional features consisting of: compactness, volume, surface area, convexity, number of branches, axis ratio, distance to a chest wall, average of gray level standard deviation of gray level, object contrast, gradient strength along a surface, roughness, and gradient direction.

43. The method of claim 38, including determining a location of the potential lung nodule within a lung and using a different expert engine based on the location of the potential lung nodule within the lung.

44. The method of claim 38, including forming the three-dimensional feature by combining a plurality of two-dimensional features of a connected structure in a plurality of consecutive ones of the CT images.

45. The method of claim 38, comprising guiding a feature selection for selecting one of the two-dimensional or the three-dimensional features with the use of a genetic algorithm.

46. The method of claim 38, including using a statistical classifier or neural network classifier to combine the two-dimensional feature and the three-dimensional feature.

47. The method of claim 38, including displaying the lung nodule on a display.

48. The method of claim 47, wherein displaying the lung nodule includes displaying the CT images with the lung nodule identified on the images.

49. A method for classifying a lung nodule as malignant or benign using one or more computed tomography (CT) images, comprising:
identifying the lung nodule in the one or more CT images;
obtaining a first feature associated with the lung nodule;
obtaining a second feature associated with the lung nodule; and
invoking an expert engine to analyze the first feature and the second feature to determine if the lung nodule is malignant or benign.

50. The method of claim 49, further including:
obtaining a first nodule volume of the lung nodule from a first series of the CT images from a first patient exam;
obtaining a second nodule volume of the lung nodule from a second series of the CT images from a second patient exam;
comparing the first nodule volume to the second nodule volume to determine a growth indication of the lung nodule; and
using the growth indication to determine if the lung nodule is benign or malignant.

51. The method of claim 50, wherein the first patient exam is a prior exam and the second patient exam is a current exam that is obtained on a later date.

52. The method of claim 49, including obtaining a feature associated with the lung nodule as the first feature from the first patient exam and obtaining the same feature associated with the lung nodule as the second feature from the second patient exam

53. The method of claim 52, wherein the first feature and the second feature are extracted from the lung nodule in the first and second exams, the first feature and the second feature being features selected from the group of features consisting of: morphological features, texture features, and spiculation features.

54. The method of claim 52, including quantifying a temporal change between the first and second features and using the temporal change to determine if the lung nodule is benign or malignant.

55. The method of claim 54, including using a similarity measure to quantify the temporal change, the similarity measure selected from a group of similarity measures consisting of: a Euclidean distance, a scalar product, a difference between the first and second features, an average between the first and second features, and a correlation between the first and second features

56. The method of claim 55, including combining the similarity measure with the first and second features to determine if the lung nodule is malignant or benign.

57. The method of claim 56, including invoking an expert engine to combine the similarity measure with the first and second set of features and to determine if the lung nodule is malignant or benign.

58. The method of claim 49, including extracting a spiculation feature associated with the lung nodule as the first or second feature.

59. The method of claim 49, including extracting a texture feature associated with the lung nodule as the first or second feature.

60. The method of claim 59, wherein the texture feature is selected from the group of texture features consisting of: thirteen spatial gray-level dependence feature measures, and five run length statistics measures.

61. The method of claim 59, wherein the texture feature is a texture feature selected from the group of texture features consisting of: horizontal run percentage, vertical run percentage, horizontal short run emphasis, vertical short run emphasis, horizontal long run emphasis, vertical long run emphasis, horizontal run length nonuniformity, horizontal gray level nonuniformity, information measure of correlation, inertia, difference variance, energy, correlation, and difference average.

62. The method of claim 49, wherein invoking an expert engine includes invoking a neural network to determine if the lung nodule is malignant or benign.

63. The method of claim 49, wherein invoking an expert engine includes invoking the expert engine to analyze a risk factor, the risk factor related to a risk of lung cancer.

64. The method of claim 49, wherein invoking an expert engine includes transforming a band of pixels surrounding the lung nodule to a rectangular coordinate system using a rubber-band straightening transform in a plurality of two dimensional CT slices or in a three dimensional CT volume.

65. The method of claim 49, wherein invoking an expert engine includes analyzing the number of blood vessels connected to the lung cancer nodule.

66. The method of claim 49, wherein invoking an expert engine includes analyzing an amount of calcification in the lung cancer nodule.

67. The method of claim 49, wherein invoking the expert engine includes invoking a stepwise feature selection with a simplex optimization to select an optimal subset of features for classification as malignant or benign.

68. The method of claim.49, including displaying the lung nodule on a display.

69. The method of claim 68, wherein displaying the lung nodule includes displaying the one or more CT images with the lung nodule identified on the images.

70. The method of claim 69, wherein displaying the lung nodule includes displaying an indication of whether the lung nodule is malignant or benign.

71. A method of identifying a vascular structure in a lung region from a set of computed tomography (CT) images, comprising:
identifying an indentation in a mediastinal border of the lung region;
using the indentation as a starting point to grow the vascular structure;
centering a cube at the starting point, the cube having a side length larger than the vascular structure;
segmenting the vascular structure from a background;
determining a first sphere to enclose a segmented vascular structure volume;
recording a center of the first sphere as a first tracked point;
identifying a second tracked point;
centering a second sphere at the second tracked point, the second sphere having a diameter larger than the vessel diameter at the first tracked point;
searching a surface of the second sphere for one or more intersections with a branching vascular structure and the vascular structure;
identifying a vascular structure center, the vascular structure center being a centroid of an intersecting region between the vascular structure and the surface of the second sphere;
continuing the vascular structure based on a branch having a set of branch features closest to a set of vascular features associated with the vascular structure; and
identifying a third tracked point as a branch centroid of the branch.

72. The method of claim 71, including segmenting the vascular structure from the background using an expectation-maximization algorithm.

73. The method of claim 71, including tracking a next tracked point using a third sphere having a diameter that is adapted to a local vessel size.

74. The method of claim 71, including searching the surface of the second sphere for one or more intersections using a differentiation in gray level, a differentiation in size, and a differentiation in shape.

75. The method of claim 71, wherein the set of branch features and the set of vascular features are selected from the group of features consisting of: diameter, gray level, and direction.

76. The method of claim 71, including determining a tracking direction as a direction vector extending from the second tracked point to the third tracked point.

77. The method of claim 71, including forming a centerline of a part of the vascular structure by connecting the first, second, and third tracked points.

78. The method of claim 71, including tracking the vascular structure until a diameter and a contrast of the vascular structure falls below predetermined thresholds.

79. The method of claim 71, including tracking the vascular structure until it is tracked beyond a predetermined region of the lung.

80. The method of claim 71, wherein the second sphere has a diameter 1.5 times larger than the first sphere.

81. A method of differentiating a blood vessel from a lung nodule in a computed tomography (CT) image, comprising:
identifying a potential lung nodule on the CT image;
extracting a shape feature associated with the potential lung nodule;
invoking a classification engine to analyze the shape feature to determine if the potential lung nodule is a branching shaped object or a round shaped object, and
classifying the potential lung nodule based on determining if the potential lung nodule is a branching shaped object or a round shaped object.

82. The method of claim 81, including invoking a classification engine to analyze the shape feature to determine if the potential lug nodule is a long, thin object or the round shaped object.

83. The method of claim 82, including classifying the potential lung nodule based on determining if the potential lung nodule is the long, thin object or the round shaped object.

84. The method of claim 81, including growing the potential lung nodule into a three-dimensional object across a plurality of consecutive CT images.

85. The method of claim 84, including growing the potential lung nodule using a 26-connectivity rule.

86. The method of claim 85, including using a three-dimensional active contour model to extract the potential nodule shape in a volume of CT images.

87. The method of claim 81, including using a classification rule that sets a lower limit on a size of a bounding box used to analyze the potential lung nodule.

88. The method of claim 81, wherein the shape feature is a branching shape.

89. The method of claim 8 1, wherein the shape feature is a long, thin shape.

90. The method of claim 81, including identifying the potential lung nodule from a set of potential lung nodules and excluding from the set objects that overlap with an extracted vessel tree are.

91. A method of displaying lung nodule information to a user on a display screen, comprising:
displaying a lung region to the user via the display screen;
specifying one or more objects within the lung region as lung nodules;
determining classification information about the one or more objects specified as lung nodules related to whether one of the one or more objects is benign or malignant; and
displaying the classification information about the one of the one or more objects to the user via the display screen.

92. The method of claim 91, wherein specifying the one or more objects includes allowing the user to specify the one or more the objects which are to be considered as lung nodules.

93. The method of claim 91, wherein specifying the one or more objects includes automatically processing one or more computed tomography (CT) images of the lung region to determine a potential lung nodule and displaying the determined potential lung nodule as one of the one or more objects.

94. The method of claim 93, wherein displaying the determined potential lung nodule includes enabling the user to specify when to display the determined potential lung nodule and displaying the determined potential lung nodule after the user has specified to display the determined potential lung nodule.

95. The method of claim 91, wherein displaying the lung region includes displaying a computed tomography (CT) image of the lung region to the user.

96. The method of claim 91, wherein displaying the lung region includes generating a three dimensional depiction of the lung region from a series of computed tomography (CT) images and displaying the three dimensional depiction of the lung region to the user.

97. Tile method of claim 91, wherein determining classification information about the one or more objects includes determining whether one of the one or more objects is benign or malignant as the classification information.

98. The method of claim 91, wherein determining classification information about the one or more objects includes determining a likelihood of one of the one or more objects being benign or malignant as the classification information.

99. The method of claim 91, wherein displaying the classification information includes displaying the classification information about one of the one or more objects next to a depiction of the one of the one or more objects on the display.

100. The method of claim 91, wherein displaying the classification information includes enabling the user to specify when to display the classification information and displaying the classification information after the user has specified to display the classification information.

101. A method of recovering a juxta-pleura nodule within in a lung represented on a computed tomography (CT) image, comprising:
identifying a lung boundary in the CT image;
choosing a first point and a second point on the lung boundary which are not adjacent one another on the lung boundary;
computing a first distance as a distance between the first point and the second point in a first direction along the lung boundary;
computing a second distance as a distance between the first point and the second point in a second direction along the lung boundary;
computing a third distance as a straight line distance between the first point and the second point;
determining a relationship between the third distance and at least one of the first and second distances; and
defining the lung boundary to include the straight line between the first point and the second point based on the relationship, to thereby return the juxta-plura nodule to be within the space defined by the lung boundary.

102. The method of claim 101, wherein determining the relationship includes determining a ratio between the third distance and a minimum of the first and second distances.

103. The method of claim 101, wherein defining the lung boundary includes defining the lung boundary to include the straight line between the first point and the second point when a ratio of the third distance to one of the first and second distances is less than a predetermined threshold.

104. The method of claim 101, wherein defining the lung boundary includes defining the lung boundary to include the straight line between the first point and the second point when a ratio of the third distance to a minimum of the first and second distances is less than a predetermined threshold.

105. The method of claim 101, wherein defining the lung boundary includes defining the lung boundary to include the straight line between the first point and the second point when a ratio of one of the first and second distances to the third distance is greater than a predetermined threshold.

106. The method of claim 105, wherein the predetermined threshold is approximately 1.5.

107. The method of claim 101, wherein defining the lung boundary includes defining the lung boundary to include the straight line between the first point and the second point when a ratio of a minimum of the first and second distances to the third distance is greater than a predetermined threshold.

108. The method of claim 107, wherein the predetermined threshold is approximately 1.5.

109. The method of claim 101, wherein determining a relationship between the third distance and at least one of the first and second distances includes determining a relationship between the third distance and a combination of the first and second distances.

110. A method for detecting a lung nodule attached to a vascular structure using one or more computed tomography (CT) images, comprising:
determining a vascular tree from the CT images;
eroding the vascular tree using a morphological erosion operation with a circular erosion element;
defining n plurality of three dimensional objects in the vascular tree;
finding the compactness ratio and the diameter of the smallest enclosing sphere for each of the plurality of three dimensional objects;
setting a threshold on the compactness ratio and the diameter to differentiate the vascular tree from potential nodules that are attached to the vascular tree; and
identifying each of the plurality of three dimensional objects that is below a threshold for diameter or above a threshold for compactness as a lung nodule.

111. The method of claim 110, wherein defining a plurality of three dimensional objects in the vascular tree includes using 26-connectivity to define points connected to one another.

112. A method for processing an object detected in a set of computed tomography (CT) images, comprising:
identifying an object in three dimensions from the set of CT images;
defining a contour of the object based on points defining the boundary of the object in the set of CT images; and
processing the contour of the object to smooth the shape of the contour in three dimensions.

113. The method of claim 112, wherein defining the contour of the object includes generalizing two dimensional active contour models for the object determined from different ones of the CT images into three dimensions.

114. The method of claim 113, wherein generalizing two dimensional active-contour models includes determining contour continuity and curvature parameters for the object from two or more different ones of the CT images and combining the contour continuity and curvature parameters to generate the object in three dimensions with a smoother shape.

115. The method of claim 112, wherein processing the contour of the object includes using one or more energy terms to move vertices of the object towards high three dimensional image gradients.

116. The method of claim 112, wherein processing the contour of the object includes using a continuity term to assure that vertices of the object are uniformly distributed over a volume of the object in three dimensions.
